(19) United States
(12) Patent Application Publication
(10) Pub. No.: US 2026/0321202 A1
(43) Pub. Date: Oct. 15, 2026

(54) PIXEL CIRCUIT, DRIVING METHOD THEREOF AND DISPLAY DEVICE

(71) Applicants: HEFEI BOE JOINT TECHNOLOGY CO., LTD., Hefei (CN); BOE TECHNOLOGY GROUP CO., LTD., Beijing (CN); BEIJING BOE TECHNOLOGY DEVELOPMENT CO., LTD., Beijing (CN)

(72) Inventors: Xuehuan FENG, Beijing (CN); Yongqian LI, Beijing (CN)

(21) Appl. No.: 18/995,455

(22) PCT Filed: Nov. 30, 2023
(86) PCT No.: PCT/CN2023/135535

§ 371 Date: Jan. 16, 2025

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0233

(57) ABSTRACT

A pixel circuit, a driving method thereof and a display device. In the pixel circuit, the control terminal of that first compensation circuit is configured to receive the first compensation control signal, the first terminal of the first compensation circuit is electrically connected with the first terminal of the driving circuit, and the second terminal of the first compensation circuit is electrically connected with the control terminal of the driving circuit, and the first compensation circuit is configured to control the control terminal of the driving circuit and the first terminal of the driving circuit whether to be electrically conducted through the first compensation circuit in response to the first compensation control signal; the second compensation circuit includes a compensation capacitor, and a first electrode plate of the compensation capacitor is electrically connected with the control terminal of the driving circuit.

### TECHNICAL FIELD

At least one embodiment of the present disclosure relates to a pixel circuit, a driving method thereof, and a display device.

### BACKGROUND

With the continuous development of display technology, pixel circuits with low temperature polysilicon oxide (LTPO) have been more and more used in display devices. The pixel circuits with LTPO have high refresh rate, which can realize low leakage and is beneficial to make the brightness of display panel have high uniformity. In addition, internal compensation circuit is widely used because of its low requirements for driving integrated circuit (IC), low cost and simple control algorithm.

### SUMMARY

At least one embodiment of the present disclosure provides a pixel circuit, the pixel circuit includes a driving circuit, a data writing circuit, a first compensation circuit and a second compensation circuit. The driving circuit includes a control terminal, a first terminal and a second terminal, and is configured to control a magnitude of a driving current flowing through the first terminal and the second terminal; a first terminal of the data writing circuit is electrically connected with a second terminal of the driving circuit, a second terminal of the data writing circuit is configured to receive a data signal, and the data writing circuit is configured to write the data signal into the second terminal of the driving circuit in response to a data scanning signal in a data writing stage; the first compensation circuit has a control terminal, a first terminal and a second terminal, the control terminal of the first compensation circuit is configured to receive a first compensation control signal, the first terminal of the first compensation circuit is electrically connected with the first terminal of the driving circuit, and the second terminal of the first compensation circuit is electrically connected with the control terminal of the driving circuit, and the first compensation circuit is configured to control the control terminal of the driving circuit and the first terminal of the driving circuit whether to be electrically conducted through the first compensation circuit in response to the first compensation control signal. The second compensation circuit includes a compensation capacitor, and a first electrode plate of the compensation capacitor is electrically connected with the control terminal of the driving circuit.

For example, in the pixel circuit provided by at least one embodiment of the present disclosure, the first compensation circuit and the second compensation circuit are configured to allow a potential of the control terminal of the driving circuit to change in response to a potential change of the second terminal of the driving circuit in the data writing stage, and to maintain the potential of the control terminal of the driving circuit in a compensation stage after the data writing stage and not allow the potential of the control terminal of the driving circuit to change in response to the potential change of the second terminal of the driving circuit.

For example, in the pixel circuit provided by at least one embodiment of the present disclosure, the driving circuit comprises a driving transistor, a gate electrode of the driving transistor serves as the control terminal of the driving circuit, a first electrode of the driving transistor serves as the first terminal of the driving circuit, a second electrode of the driving transistor serves as the second terminal of the driving circuit, and the first terminal of the driving circuit is electrically connected with a first power supply voltage terminal to receive a first power supply voltage; the pixel circuit further comprises a light emitting element, the light emitting element is configured to emit light driven by the driving current, the second terminal of the driving circuit is electrically connected with a first electrode of the light emitting element, and the driving circuit is configured to control a magnitude of a driving current flowing through the light emitting element; the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor.

For example, in the pixel circuit provided by at least one embodiment of the present disclosure, the second compensation circuit further comprises a second compensation transistor, a gate electrode of the second compensation transistor receives a second compensation control signal, a first electrode of the second compensation transistor is electrically connected with the gate electrode of the driving transistor, and a second electrode of the second compensation transistor is electrically connected with the first electrode plate of the compensation capacitor so that the first electrode plate of the compensation capacitor is electrically connected with the gate electrode of the driving transistor through the second compensation transistor, and a second electrode plate of the compensation capacitor is electrically connected with the second electrode of the driving transistor.

For example, in the pixel circuit provided by at least one embodiment of the present disclosure, the first electrode plate of the compensation capacitor is electrically connected with the gate electrode of the driving transistor, and a second electrode plate of the compensation capacitor is electrically connected with the first electrode of the light emitting element.

For example, in the pixel circuit provided by at least one embodiment of the present disclosure, the pixel circuit further comprises a first reset circuit, a control terminal of the first reset circuit is configured to receive a first reset control signal, a first terminal of the first reset circuit is electrically connected with the second terminal of the driving circuit, and a second terminal of the first reset circuit is electrically connected with a first reset signal terminal to receive a first reset signal, the first reset circuit is configured to write the first reset signal to the second terminal of the driving circuit in response to the first reset control signal.

For example, in the pixel circuit provided by at least one embodiment of the present disclosure, the first reset circuit comprises a first reset transistor, a gate electrode of the first reset transistor is electrically connected with a first reset control terminal to receive the first reset control signal, a first electrode of the first reset transistor is electrically connected with the second terminal of the driving circuit, and a second electrode of the first reset transistor is electrically connected with the first reset signal terminal to receive the first reset signal; the data writing circuit comprises a data writing transistor, a gate electrode of the data writing transistor is configured to receive the data scanning signal, the first electrode of the data writing transistor is electrically connected with the second terminal of the driving circuit, and the second electrode of the data writing transistor is electrically connected with a data signal terminal to receive the data signal; the data writing transistor and the first reset transistor are independent and different transistors, and the data signal terminal and the first reset signal terminal are independent and different signal terminals; or, the data writing transistor also serves as the first reset transistor, the data scanning signal also serves as the first reset control signal, and the data signal terminal also serves as the first reset signal terminal, and is configured to receive the data signal and the first reset signal at different time periods, respectively.

For example, in the pixel circuit provided by at least one embodiment of the present disclosure, the pixel circuit further comprises an auxiliary capacitor, a first electrode plate of the auxiliary capacitor is electrically connected with the second terminal of the driving circuit, and a second electrode plate of the auxiliary capacitor is electrically connected with a first reset voltage terminal.

For example, in the pixel circuit provided by at least one embodiment of the present disclosure, the pixel circuit further comprises a light emitting element, the light emitting element is configured to emit light driven by the driving current, the second terminal of the driving circuit is electrically connected with a first electrode of the light emitting element, and the driving circuit is configured to control a magnitude of a driving current flowing through the light emitting element; the pixel circuit further comprises a second reset circuit, a control terminal of the second reset circuit is configured to receive a second reset control signal, a first terminal of the second reset circuit is electrically connected with the first electrode of the light emitting element, and the second terminal of the second reset circuit is electrically connected with a second reset signal terminal to receive a second reset signal, the second reset circuit is configured to apply the second reset signal to the first electrode of the light emitting element and/or the second electrode plate of the compensation capacitor in response to the second reset control signal.

For example, in the pixel circuit provided by at least one embodiment of the present disclosure, the pixel circuit further comprises a second reset circuit, a control terminal of the second reset circuit is configured to receive a second reset control signal, a first terminal of the second reset circuit is electrically connected with the second terminal of the driving circuit, and a second terminal of the second reset circuit is electrically connected with a second reset signal terminal to receive a second reset signal, the second reset circuit is configured to apply the second reset signal to the second terminal of the driving circuit and/or the second electrode plate of the compensation capacitor in response to the second reset control signal.

For example, in the pixel circuit provided by at least one embodiment of the present disclosure, the first reset circuit comprises a first reset transistor, a gate electrode of the first reset transistor is electrically connected with a first reset control terminal to receive a first reset control signal, a first electrode of the first reset transistor is electrically connected with the second terminal of the driving circuit, and a second electrode of the first reset transistor is electrically connected with a first reset signal terminal to receive a first reset signal; the second reset circuit comprises a second reset transistor, a gate electrode of the second reset transistor is electrically connected with a second reset control terminal to receive the second reset control signal, a first electrode of the second reset transistor is electrically connected with the second terminal of the driving circuit, and a second electrode of the second reset transistor is electrically connected with the second reset signal terminal to receive the second reset signal; the first reset transistor also serves as the second reset transistor, the first reset control signal also serves as the second reset control signal, and the first reset signal terminal also serves as the second reset signal terminal, and is configured to receive the first reset signal and the second reset signal respectively in different time periods; or, the second reset transistor and the first reset transistor are independent and different transistors, and the first reset signal terminal and the second reset signal terminal are independent and different signal terminals.

For example, in the pixel circuit provided by at least one embodiment of the present disclosure, the pixel circuit further comprises a third reset circuit, a control terminal of the third reset circuit is configured to receive a third reset control signal, a first terminal of the third reset circuit is electrically connected with the first terminal of the driving circuit, and a second terminal of the third reset circuit is electrically connected with a third reset signal terminal to receive the third reset signal, the third reset circuit is configured to apply the third reset signal to the first terminal of the driving circuit in response to the third reset signal.

For example, in the pixel circuit provided by at least one embodiment of the present disclosure, the third reset circuit comprises a third reset transistor, a gate electrode of the third reset transistor is configured to receive a third reset control signal, a first electrode of the third reset transistor is electrically connected with the first electrode of the first compensation transistor and the first terminal of the driving circuit, and the first electrode of the third reset transistor is electrically connected with a third reset signal terminal to receive the third reset signal.

For example, in the pixel circuit provided by at least one embodiment of the present disclosure, the first compensation circuit comprises a first compensation transistor, a first electrode of the first compensation circuit is electrically connected with the first terminal of the driving circuit, and a second electrode of the first compensation circuit is electrically connected with a driving terminal of the driving circuit; the second reset circuit comprises a second reset transistor, a gate electrode of the second reset transistor is electrically connected with a second reset control terminal to receive a second reset control signal, a first electrode of the second reset transistor is electrically connected with the second terminal of the driving circuit, and a second electrode of the second reset transistor is electrically connected with the second reset signal terminal to receive the second reset signal; a gate electrode of the first compensation transistor and the gate electrode of the second reset transistor are connected with a same gate line, and the second reset control signal and the first compensation control signal are a same gate scanning signal.

For example, in the pixel circuit provided by at least one embodiment of the present disclosure, the pixel circuit further comprises a first light emission control circuit and a second light emission control circuit; a control terminal of the first light emission control circuit is configured to receive a first light emission control signal, a first terminal of the first light emission control circuit is electrically connected with the first terminal of the driving circuit, and a second terminal of the first light emission control circuit is electrically connected with a first voltage terminal to receive a first power supply voltage, and the first light emission control circuit is configured to apply the first power supply voltage to the first terminal of the driving circuit in response to the first light emission control signal; a control terminal of the second light emission control circuit is configured to receive a second light emission control signal, the second light emission control signal is different from the first light emission control signal, a first terminal of the second light emission control circuit is electrically connected with the second terminal of the driving circuit, a second terminal of the second light emission control circuit is electrically connected with the first electrode of the light emitting element, and the second electrode of the light emitting element is electrically connected with a second voltage terminal to receive a second power supply voltage, and the second light emission control circuit is configured to apply the driving current to the light emitting element in response to the second light emission control signal.

At least one embodiment of the present disclosure also provides a display device, the display device includes any one of the pixel circuits provided by the embodiments of the present disclosure.

At least one embodiment of the present disclosure provides a driving method of a pixel circuit, the driving method is suitable for any pixel circuit provided by the embodiment of the present disclosure. The driving method includes: in the data writing stage, setting the data scanning signal as a turn-on signal to turn on the data writing circuit, and the data signal is written to the second terminal of the driving circuit through the data writing circuit, and the potential of the control terminal of the driving circuit changes in response to the potential change of the second terminal of the driving circuit by controlling the first compensation circuit and the second compensation circuit; and in a compensation stage after the data writing stage, controlling the first compensation circuit and the second compensation circuit to maintain the potential of the control terminal of the driving circuit, the potential of the control terminal of the driving circuit is not allowed to change in response to the potential change of the second terminal of the driving circuit.

For example, in the driving method of the pixel circuit provided by at least one embodiment of the present disclosure, in the data writing stage, the first compensation control signal is set as a turn-on signal to turn on the first compensation circuit in response to the first compensation control signal, the control terminal of the driving circuit and the first terminal of the driving circuit are electrically conducted through the first compensation circuit, and the first terminal of the driving circuit and the second terminal of the driving circuit are electrically conducted, as to generate a compensation current between the control terminal of the driving circuit and the second terminal of the driving circuit, and the compensation current flows through the first compensation circuit and the driving circuit, so that the potential of the control terminal of the driving circuit changes in response to the change of a potential of the second terminal of the driving circuit; in the compensation stage, at least the first compensation control signal is set as a turn-off signal to turn off the first compensation circuit, so that no current is allowed to generate between the control terminal of the driving circuit and the second terminal of the driving circuit, and the potential of the control terminal of the driving circuit is maintained unchanged, and the potential of the control terminal of the driving circuit is not allowed to change in response to the potential change of the second terminal of the driving circuit.

For example, in the driving method of the pixel circuit provided by at least one embodiment of the present disclosure, the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit; the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor; the second compensation circuit further comprises a second compensation transistor, a gate electrode of the second compensation transistor receives a second compensation control signal, a first electrode of the second compensation transistor is electrically connected with the gate electrode of the driving transistor, and a second electrode of the second compensation transistor is electrically connected with the first electrode plate of the compensation capacitor so that the first electrode plate of the compensation capacitor is electrically connected with the gate electrode of the driving transistor through the second compensation transistor, and a second electrode plate of the compensation capacitor is electrically connected with the second electrode of the driving transistor; the pixel circuit further comprises a light emitting element, the light emitting element is configured to emit light under driving of the driving current, wherein the second terminal of the driving circuit is electrically connected with a first electrode of the light emitting element, and the driving circuit is configured to control a magnitude of a driving current flowing through the light emitting element; the driving method of the pixel circuit comprises: in the data writing stage, setting the first compensation control signal and the second compensation control signal as turn-on signals, so that both the first compensation transistor and the second compensation transistor are turned on to generate the compensation current; and in the compensation stage, turning off both the first compensation transistor and the second compensation transistor to maintain the potential of the control terminal of the driving circuit unchanged.

For example, in the driving method of the pixel circuit provided by at least one embodiment of the present disclosure, the control method of the pixel circuit further comprises: in the initial stage, setting the second compensation control signal as a turn-on signal to turn on the second compensation transistor.

For example, in the driving method of the pixel circuit provided by at least one embodiment of the present disclosure, the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit; the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor; the pixel circuit further comprises a light emitting element configured to emit light under driving of the driving current, wherein the second terminal of the driving circuit is electrically connected with a first electrode of the light emitting element, and the driving circuit is configured to control a magnitude of a driving current flowing through the light emitting element; the first electrode plate of the compensation capacitor is electrically connected with the gate electrode of the driving transistor, and a second electrode plate of the compensation capacitor is electrically connected with the first electrode of the light emitting element; the driving method comprises: in the data writing stage, setting the first compensation control signal as a turn-on signal to turn on the first compensation transistor to generate the compensation current; and in the compensation stage, setting the first compensation control signal as a turn-off signal to turn off the first compensation transistor to maintain the potential of the control terminal of the driving circuit unchanged.

For example, in the driving method of the pixel circuit provided by at least one embodiment of the present disclosure, in the data writing stage, the potential of the control terminal of the driving circuit changes in response to the potential change of the second terminal of the driving circuit until the driving transistor is turned off, and the potential VG of the control terminal of the driving circuit satisfies VG=Vdata+Vth at an end of the data writing stage.

For example, in the driving method of the pixel circuit provided by at least one embodiment of the present disclosure, a first terminal of the driving circuit is connected with a first power supply voltage terminal to receive the first power supply voltage; the driving method further comprises: in an initial stage before the data writing stage, setting the first compensation control signal as a turn-on signal to turn on the first compensation circuit, and the first power supply voltage is written to the driving terminal of the driving circuit sequentially through the first terminal of the driving circuit and the first compensation circuit to electrically conduct the first terminal and the second terminal of the driving circuit.

For example, in the driving method of the pixel circuit provided by at least one embodiment of the present disclosure, the pixel circuit further comprises a first reset circuit, a control terminal of the first reset circuit is configured to receive a first reset control signal, a first terminal of the first reset circuit is electrically connected with the second terminal of the driving circuit, and a second terminal of the first reset circuit is electrically connected with a first reset signal terminal to receive a first reset signal, the first reset circuit is configured to write the first reset signal to the second terminal of the driving circuit in response to the first reset control signal, the pixel circuit further comprises a second reset circuit, a control terminal of the second reset circuit is configured to receive a second reset control signal, a first terminal of the second reset circuit is electrically connected with the first electrode of the light emitting element, and the second terminal of the second reset circuit is electrically connected with a second reset signal terminal to receive the second reset signal, the second reset circuit is configured to apply the second reset signal to the first electrode of the light emitting element and the second electrode plate of the compensation capacitor in response to the second reset control signal, the driving method comprises: in an initial stage, setting all the first reset control signal, the second reset control signal and the first compensation control signal as turn-on signals, so that the first reset circuit is turned on and the first reset signal to the second terminal of the driving circuit, and the second reset circuit is turned on and the second reset signal is applied to the first electrode of the light emitting element.

For example, in the driving method of the pixel circuit provided by at least one embodiment of the present disclosure, the pixel circuit further comprises a first light emission control circuit and a second light emission control circuit; a control terminal of the first light emission control circuit is configured to receive a first light emission control signal, a first terminal of the first light emission control circuit is electrically connected with the first terminal of the driving circuit, and a second terminal of the first light emission control circuit is electrically connected with a first voltage terminal to receive a first power supply voltage; a control terminal of the second light emission control circuit is configured to receive a second light emission control signal, the second light emission control signal is different from the first light emission control signal, and a first terminal of the second light emission control circuit is electrically connected with the second terminal of the driving circuit; the second compensation circuit further comprises a second compensation transistor, a gate electrode of the second compensation transistor receives a second compensation control signal, a first electrode of the second compensation transistor is electrically connected with the gate electrode of the driving transistor, and a second electrode of the second compensation transistor is electrically connected with the first electrode plate of the compensation capacitor, so that the first electrode plate of the compensation capacitor is electrically connected with the gate electrode of the driving transistor through the second compensation transistor, and the second electrode plate of the compensation capacitor is electrically connected with the second electrode of the driving transistor; the driving method comprises: in the compensation stage, setting both the second light emission control signal and the second reset control signal as turn-on signals, and setting the first light emission control signal as a turn-off signal, so that both the second light emission control circuit and the second reset circuit are turned on, and the second reset signal is written to the second terminal of the driving circuit through the second light emission control circuit, so that the potential VN3 of the second terminal of the driving circuit satisfies VN3=Vini; and in the compensation stage, the potential of the control terminal of the driving circuit is maintained at a potential at an end of the data writing stage.

For example, in the driving method of the pixel circuit provided by at least one embodiment of the present disclosure, the pixel circuit further comprises a first light emission control circuit and a second light emission control circuit; a control terminal of the first light emission control circuit is configured to receive a first light emission control signal, a first terminal of the first light emission control circuit is electrically connected with the first terminal of the driving circuit, and a second terminal of the first light emission control circuit is electrically connected with a first voltage terminal to receive a first power supply voltage; a control terminal of the second light emission control circuit is configured to receive a second light emission control signal, the second light emission control signal is different from the first light emission control signal, and a first terminal of the second light emission control circuit is electrically connected with the second terminal of the driving circuit; the pixel circuit further comprises a light emitting element configured to emit light driven by the driving current, a second terminal of the driving circuit is electrically connected with a first electrode of the light emitting element, and the driving circuit is configured to control a magnitude of a driving current flowing through the light emitting element; the first electrode plate of the compensation capacitor is electrically connected with the gate electrode of the driving transistor, and a second electrode plate of the compensation capacitor is electrically connected with the first electrode of the light emitting element; the driving method comprises: in the compensation stage, setting the second reset control signal as a turn-on signal and setting the first light emission control signal as a turn-off signal, wherein the second reset signal is written to the first electrode of the light emitting element through the second reset circuit, so that the potential VN4 of the first electrode of the light emitting element satisfies VN4=Vini, and in the compensation stage, the potential of the control terminal of the driving circuit is maintained at a potential at an end of the data writing stage.

For example, in the driving method of the pixel circuit provided by at least one embodiment of the present disclosure, in the initial stage, the first light emission control signal is set as a turn-on signal to turn on the first light emission control circuit, and the first power supply voltage is written to the first terminal of the driving circuit through the first light emission control circuit; and, in the data writing stage, both the first light emission control signal and the second light emission control signal are set as turn-off signals.

For example, in the driving method of the pixel circuit provided by at least one embodiment of the present disclosure, the data signal is a data voltage, and the first power supply voltage written in the initial stage is higher than the data voltage written in the data writing stage.

For example, in the driving method of the pixel circuit provided by at least one embodiment of the present disclosure, the second reset control signal and the first compensation control signal are a same gate scanning signal.

For example, in the driving method of the pixel circuit provided by at least one embodiment of the present disclosure, the driving method of the pixel circuit further comprises: in a light emitting stage after the compensation stage, setting both the first light emission control signal and the second light emission control signal as turn-on signals, and setting all the data scanning signal, the first reset control signal, the second reset control signal and the first compensation control signal as turn-off signals, so that both the first light emission control circuit and the second light emission control circuit are turned on, and the data writing circuit, the first reset circuit, the second reset circuit and the first compensation circuit are all turned off, to form the driving current flowing through the first light emission control circuit, the driving circuit, the second light emission control circuit and the light emitting element.

For example, in the driving method of the pixel circuit provided by at least one embodiment of the present disclosure, in a case where the second compensation circuit further comprises a second compensation transistor, a gate electrode of the second compensation transistor receives a second compensation control signal, a first electrode of the second compensation transistor is electrically connected with the gate electrode of the driving transistor, and the second electrode of the second compensation transistor is electrically connected with the first electrode plate of the compensation capacitor so that the first electrode plate of the compensation capacitor is electrically connected with the gate electrode of the driving transistor through the second compensation transistor, and the second electrode plate of the compensation capacitor is electrically connected with the second electrode of the driving transistor, the driving method of the pixel circuit further comprises: in the light emitting stage after the compensation stage, setting the second compensation control signal as a turn-on signal to turn on the second compensation control transistor.

For example, in the driving method of the pixel circuit provided by at least one embodiment of the present disclosure, the pixel circuit further comprises a third reset circuit, a control terminal of the third reset circuit is configured to receive a third reset control signal, a first terminal of the third reset circuit is electrically connected with the first terminal of the driving circuit, and a second terminal of the third reset circuit is electrically connected with a third reset signal terminal to receive a third reset signal; the driving method of the pixel circuit further comprises: in the initial stage, setting the third reset control signal as a turn-on signal to turn on the third reset circuit, and the third reset signal is applied to the first terminal of the driving circuit through the third reset circuit.

For example, in the driving method of the pixel circuit provided by at least one embodiment of the present disclosure, the first terminal of the driving circuit is connected with a first power supply voltage terminal to receive the first power supply voltage; the third reset signal is a reset voltage, and the reset voltage is lower than the first power supply voltage.

### BRIEF DESCRIPTION OF DRAWINGS

In order to explain the technical solution of the embodiments of the present disclosure more clearly, the attached drawings of the embodiments of the present disclosure will be briefly introduced below. The attached drawings are only used to show some embodiments of the present disclosure, and are not limited to all embodiments of the present disclosure.

FIG. 1 is a schematic block diagram of a pixel circuit provided by an embodiment of the present disclosure;

FIG. 2 is a circuit diagram of a specific example of the pixel circuit shown in FIG. 1;

FIG. 3 is a signal timing diagram of a driving method of the pixel circuits shown in FIGS. 1 and 2 provided by at least one embodiment of the present disclosure;

FIG. 4A is a schematic diagram of a working state of the pixel circuit shown in FIG. 2 in an initial stage;

FIG. 4B is a schematic diagram of a working state of the pixel circuit shown in FIG. 2 in the data writing stage;

FIG. 4C is a schematic diagram of a working state of the pixel circuit shown in FIG. 2 in the light emitting stage;

FIG. 4D is a schematic diagram of a working state of the pixel circuit shown in FIG. 2 in the compensation stage;

FIG. 5 is a schematic block diagram of another pixel circuit provided by at least one embodiment of the present disclosure;

FIG. 6 is a circuit diagram of a specific example of the pixel circuit shown in FIG. 5;

FIG. 7 is a signal timing diagram of a driving method of the pixel circuits shown in FIGS. 5 and 6 provided by at least one embodiment of the present disclosure;

FIG. 8 is a schematic block diagram of another pixel circuit provided by at least one embodiment of the present disclosure;

FIG. 9 is a circuit diagram of a specific example of the pixel circuit shown in FIG. 8;

FIG. 10 is a signal timing diagram of a driving method of the pixel circuits shown in FIGS. 8 and 9 provided by at least one embodiment of the present disclosure;

FIG. 11 is a schematic block diagram of another pixel circuit provided by at least one embodiment of the present disclosure;

FIG. 12 is a circuit diagram of a specific example of the pixel circuit shown in FIG. 11;

FIG. 13 is a signal timing diagram of a driving method of the pixel circuits shown in FIGS. 11 and 12 provided by at least one embodiment of the present disclosure;

FIG. 14 is a schematic block diagram of another pixel circuit provided by at least one embodiment of the present disclosure;

FIG. 15 is a circuit diagram of a specific example of the pixel circuit shown in FIG. 14;

FIG. 16 is a signal timing diagram of a driving method of the pixel circuits shown in FIGS. 14 and 15 provided by at least one embodiment of the present disclosure;

FIG. 17 is a schematic block diagram of another pixel circuit provided by at least one embodiment of the present disclosure;

FIG. 18 is a circuit diagram of a specific example of the pixel circuit shown in FIG. 17;

FIG. 19 is a signal timing diagram of a driving method of the pixel circuits shown in FIGS. 17 and 18 provided by at least one embodiment of the present disclosure;

FIG. 20 is a circuit diagram of another pixel circuit provided by at least one embodiment of the present disclosure;

FIG. 21 is a signal timing diagram of a driving method of the pixel circuit shown in FIG. 20 provided by at least one embodiment of the present disclosure;

FIG. 22 is a circuit diagram of another specific example of the pixel circuit shown in FIG. 1;

FIG. 23 is a signal timing diagram of a driving method of the pixel circuit shown in FIG. 22;

FIG. 24 is a circuit diagram of another specific example of the pixel circuit shown in FIG. 17; and

FIG. 25 is a schematic block diagram of a display device provided by at least one embodiment of the present disclosure.

### DETAILED DESCRIPTION

In order to make the purpose, technical solution and advantages of the embodiments of the present disclosure more clear, the technical solution of the embodiments of the disclosure will be described clearly and completely with the attached drawings. Obviously, the described embodiment is a part of the embodiments of the present disclosure, not the whole embodiment. Based on the described embodiments of the present disclosure, all other embodiments obtained by ordinary skilled in the art without creative labor belong to the scope of protection of the present disclosure.

Unless otherwise defined, technical terms or scientific terms used here shall have their ordinary meanings as understood by people with ordinary skills in the field to which this present disclosure belongs. The “first”, “second” and similar words used in the specification and claims of the present disclosure patent application do not indicate any order, quantity or importance, but are only used to distinguish different components. Similar words such as “including” or “containing” mean that the elements or objects appearing before the word cover the elements or objects listed after the word and their equivalents, without excluding other elements or objects. Similar words such as “connecting” or “connected” are not limited to physical or mechanical connection, but can include electrical connection, whether direct or indirect. “Up”, “Down”, “Left” and “Right” are only used to indicate the relative positional relationship. When the absolute position of the described object changes, the relative positional relationship may also change accordingly.

Features such as “vertical”, “parallel” and “identical” used in the embodiments of the present disclosure all include features such as “vertical”, “parallel” and “identical” in a strict sense, and cases such as “approximately vertical”, “approximately parallel” and “approximately identical” contain certain errors, which is within the acceptable deviation range for a specific value determined by those ordinary skilled in the art upon considering the measurement and the error related to the measurement of a specific quantity (that is, the limitation of the measurement system). The “center” in the embodiments of the present disclosure may include a strictly geometric center position and a roughly central position in a small area around the geometric center.

In a pixel circuit, because the threshold voltage of the driving transistor can affect the display brightness, when the threshold voltage is unstable, it will lead to uneven brightness. In order to solve this problem, it is needed to compensate the threshold voltage of the driving transistor. Compensating the threshold voltage of the driving transistor can solve the problem of uneven display brightness of the display panel.

At least one embodiment of the present disclosure provides a pixel circuit, the pixel circuit includes a driving circuit, a data writing circuit, a first compensation circuit and a second compensation circuit. The driving circuit includes a control terminal, a first terminal and a second terminal, and is configured to control a magnitude of a driving current flowing through the first terminal and the second terminal; a first terminal of the data writing circuit is electrically connected with a second terminal of the driving circuit, a second terminal of the data writing circuit is configured to receive a data signal, and the data writing circuit is configured to write the data signal into the second terminal of the driving circuit in response to a data scanning signal in a data writing stage; the first compensation circuit has a control terminal, a first terminal and a second terminal, the control terminal of the first compensation circuit is configured to receive a first compensation control signal, the first terminal of the first compensation circuit is electrically connected with the first terminal of the driving circuit, and the second terminal of the first compensation circuit is electrically connected with the control terminal of the driving circuit, and the first compensation circuit is configured to control the control terminal of the driving circuit and the first terminal of the driving circuit whether to be electrically conducted through the first compensation circuit in response to the first compensation control signal. The second compensation circuit includes a compensation capacitor, and a first electrode plate of the compensation capacitor is electrically connected with the control terminal of the driving circuit.

At least one embodiment of the present disclosure also provides a display device, the display device includes any one of the pixel circuits provided by the embodiments of the present disclosure.

At least one embodiment of the present disclosure provides a driving method of a pixel circuit, the driving method is suitable for any pixel circuit provided by the embodiment of the present disclosure. The driving method includes: in the data writing stage, setting the data scanning signal as a turn-on signal to turn on the data writing circuit, and the data signal is written to the second terminal of the driving circuit through the data writing circuit, and the potential of the control terminal of the driving circuit changes in response to the potential change of the second terminal of the driving circuit by controlling the first compensation circuit and the second compensation circuit; and in a compensation stage after the data writing stage, controlling the first compensation circuit and the second compensation circuit to maintain the potential of the control terminal of the driving circuit, the potential of the control terminal of the driving circuit is not allowed to change in response to the potential change of the second terminal of the driving circuit.

It should be noted that, in the present application, the direct connection of “A and B” refers to that there are no other switching elements between A and B, for example, they are only electrically connected through wires, and the switching elements can be any switching elements such as transistors that can be controlled to be turned on and off as required. A and B respectively represent elements or electrodes that can be electrically connected.

Illustratively, FIG. 1 is a schematic block diagram of a pixel circuit provided by an embodiment of the present disclosure. Referring to FIG. 1, a pixel circuit 10 provided by an embodiment of the present disclosure includes a driving circuit 100, a data writing circuit 200, a first compensation circuit 800 and a second compensation circuit 900. The driving circuit 100 includes a control terminal 100m, a first terminal 100a and a second terminal 100b, and is configured to control a magnitude of a driving current flowing through the first terminal 100a and the second terminal 100b, that is, to control the magnitude of the driving current flowing through a light emitting element 400EL electrically connected with the driving circuit 100; the first terminal 200a of the data writing circuit 200 is electrically connected with the second terminal 100b of the driving circuit 100, and the second terminal 200b of the data writing circuit 200 is configured to receive a data signal Vdata, and the data writing circuit 200 is configured to write the data signal Vdata to the second terminal 100b of the driving circuit 100 in response to a data scanning signal G1 in a data writing stage; the first compensation circuit 800 includes a control terminal 800m, a first terminal 800a and a second terminal 800b, the control terminal 800m of the first compensation circuit 800 is configured to receive a first compensation control signal G4, the first terminal 800a of the first compensation circuit 800 is electrically connected with the first terminal 100a of the driving circuit 100, and the second terminal 800b of the first compensation circuit 800 is electrically connected with the control terminal 100m of the driving circuit 100, and the first compensation circuit 800 is configured to control the control terminal 100m of the driving circuit 100 and the first terminal 100a of the driving circuit 100 whether to be electrically conducted through the first compensation circuit 800 in response to the first compensation control signal G4. The second compensation circuit 900 includes a compensation capacitor, and the first electrode plate of the compensation capacitor C1 is electrically connected with the control terminal 100m of the driving circuit 100.

In the pixel circuit 10 provided by the embodiment of the present disclosure, the data signal Vdata can be written to the second terminal 100b of the driving circuit 100 through the data writing circuit 200, and the potential of the control terminal 100m of the driving circuit 100 can change in response to the potential change of the second terminal 100b of the driving circuit 100 by controlling the first compensation circuit 800 and the second compensation circuit 900 containing the compensation capacitor, thereby the data signal Vdata written to the second terminal 100b of the pixel circuit 10 participates in the adjustment of the potential of the control terminal 100m of the driving circuit 100, and thereby the data signal Vdata participates in the compensation calculation of the threshold voltage of the driving circuit 100. Moreover, the pixel circuit 10 can maintain, in a compensation stage after the data writing stage, the potential of the control terminal 100m of the driving circuit 100 at the potential of the control terminal 100m of the driving circuit 100 at an end of the data writing stage by controlling working states of the first compensation circuit 800 and the second compensation circuit 900, and the potential of the control terminal 100m of the driving circuit 100 is not allowed to change in response to the potential change of the second terminal 100b of the driving circuit 100, so that the potential of the control terminal 100m of the driving circuit 100 can participate in the compensation calculation of the threshold voltage of the driving circuit 100. That is, the first compensation circuit 800 and the second compensation circuit 900 are configured to allow the potential of the control terminal 100m of the driving circuit 100 to change in response to the potential change of the second terminal 100b of the driving circuit 100 in the data writing stage, and are configured to, in the compensation stage after the data writing stage, maintain the potential of the control terminal 100m of the driving circuit 100 and not to allow the potential of the control terminal 100m of the driving circuit 100 to change in response to the potential change of the second terminal 100m of the driving circuit 100. Moreover, in the light emitting stage, the potential of the control terminal 100m of the driving circuit 100 can be changed through the compensation capacitor of the second compensation circuit 900, so that the compensation of the threshold voltage of the driving circuit 100 can be realized in the light emitting stage, and the driving current is independent of the threshold voltage of the driving circuit 100, thereby improving the light emitting uniformity of pixels driven by the pixel circuit 10.

For example, referring to FIG. 1, a first terminal 100a of a driving circuit 100 is electrically connected with a first power supply voltage terminal ELVDD to receive a first power supply voltage VDD. For example, the pixel circuit 10 further includes a light emitting element 400, the light emitting element 400 is configured to emit light under the driving of a driving current, a second terminal 100b of the driving circuit 100 is electrically connected with a first electrode of the light emitting element 400, and the driving circuit 100 is configured to control the magnitude of the driving current flowing through the light emitting element 400. A second electrode 400b of the light emitting element 400 is electrically connected with a second voltage terminal ELVSS to receive a second power supply voltage VSS. For example, the first power supply voltage VDD is at a high level and the second power supply voltage VSS is at a low level. For example, the second voltage terminal ELVSS can be grounded, that is, the second power supply voltage VSS can be 0V. For example, the second power supply voltage VSS may be a negative voltage. For example, the light emitting element can be realized as a light emitting diode (LED), such as an organic light emitting diode (OLED), a quantum dot light emitting diode (QLED) or an inorganic light emitting diode; the light emitting element can be a Mini light emitting diode (Micro LED) or a Mini-OLED, and the embodiments of the present disclosure do not limit the types of light emitting elements.

For example, as illustrated by FIG. 1, the pixel circuit 10 further includes a first reset circuit 300, a control terminal 300m of the first reset circuit 300 is configured to receive a first reset control signal G2, the first terminal 300a of the first reset circuit 300 is electrically connected with the second terminal 100b of the driving circuit 100, and the second terminal 300b of the first reset circuit 300 is electrically connected with a first reset signal terminal Vref1 to receive a first reset signal Vref1. The first reset circuit 300 is configured to write the first reset signal Vref1 to the second terminal 100b of the driving circuit 100 in response to the first reset control signal G2. Therefore, for example, the first reset signal Vref1 is a relatively low reference voltage, so that the second terminal 100b of the driving circuit 100 can be reset in the initial stage, so that the voltage of the second terminal 100b of the driving circuit 100 is a relatively low reference voltage, so as to prepare for the subsequent compensation of the threshold voltage of the driving transistor DT.

For example, as illustrated by FIG. 1, the pixel circuit further includes a second reset circuit 500, a control terminal 500m of second reset circuit 500 is configured to receive a second reset control signal G3, a first terminal 500a of second reset circuit 500 is electrically connected with the first electrode 400a of the light emitting element 400, and a second terminal 500b of second reset circuit 500 is electrically connected with a second reset signal terminal Vini to receive the second reset signal Vini. The second reset circuit 500 is configured to apply the second reset signal Vini to the first electrode 400a of the light emitting element 400 and/or a second electrode plate of the compensation capacitor C1 in response to the second reset control signal G3. Thus, for example, the second reset signal Vini may be applied to the first electrode 400a of the light emitting element 400 in an initial stage to reset the voltage of the first electrode 400a of the light emitting element 400. For example, in the compensation stage, the first electrode 400a of the light emitting element 400 can be electrically connected with the second electrode of the driving transistor DT, so that the second reset signal Vini is applied to the second electrode of the driving transistor DT. Because the second electrode plate of the compensation capacitor C1 is electrically connected with the second electrode of the driving transistor DT, the second reset signal Vini is applied to the second electrode plate of the compensation capacitor C1, so as to cooperate with the control of the potential of the control terminal of the driving circuit 100 and the second terminal 100b of the driving circuit in other working stages, so as to realize the compensation of the threshold voltage of the driving transistor.

For example, as illustrated by FIG. 1, the pixel circuit 10 further includes a first light emission control circuit 600. A control terminal 600m of the first light emission control circuit 600 is configured to receive a first light emission control signal EM1, a first terminal 600a of the first light emission control circuit 600 is electrically connected with the first terminal 100a of the driving circuit 100, and a second terminal 600b of the first light emission control circuit 600 is electrically connected with the first voltage terminal ELVDD to receive the first power supply voltage VDD, and the first light emission control circuit 600 is configured to apply the first power supply voltage VDD to the first terminal 100a of the driving circuit 100 in response to the first light emission control signal EM1. For example, in an initial stage, the first light emission control circuit 600 may be turned on in response to the first light emission control signal EM1, so that the first power supply voltage VDD may be applied to the first terminal 100a of the driving circuit 100. For example, in the light emitting stage, the first light emission control circuit 600 can also be turned on in response to the first light emission control signal EM1, so that the second power supply voltage VDD can be applied to the first terminal 100a of the driving circuit 100, and when the driving circuit 100 is turned on, the second power supply voltage VDD is written to the second terminal 100b of the driving circuit 100. The second terminal 400b of the light emitting element 400 receives the second power supply voltage VSS, and the light emitting element 400 emits light under the action of the first power supply voltage VDD and the second power supply voltage VSS.

For example, as illustrated by FIG. 1, the pixel circuit 10 further includes a second light emission control circuit 700. A control terminal 700m of the second light emission control circuit 700 is configured to receive a second light emission control signal EM2, the second light emission control signal EM2 is different from the first light emission control signal EM1. A first terminal 700a of the second light emission control circuit 700 is electrically connected with the second terminal 100b of the driving circuit 100, and a second terminal 700b of the second light emission control circuit 700 is electrically connected with the first electrode 400a of the light emitting element 400. The second light emission control circuit 700 is configured to apply a driving current to the light emitting element 400 in response to the second light emission control signal EM2 and allow the second reset signal Vini to be applied to the second terminal 100b of the driving circuit 100 through the second light emission control circuit 700. For example, in the light emitting stage, the second light emission control circuit 700 may be turned on in response to the second light emission control signal EM2, so that the driving circuit 100 may apply a driving current to the light emitting element 400 through the second light emission control circuit 700 to make the light emitting element 400 emit light. For example, in the compensation stage, the second light emission control circuit 700 can also be turned on in response to the second light emission control signal EM2, so that the first electrode 400a of the light emitting element 400 and the second electrode of the driving transistor DT are electrically connected through the second light emission control circuit 700, thereby applying the second reset signal Vini to the second electrode of the driving transistor DT and the second electrode plate of the compensation capacitor C1, so as to cooperate with the control of the potential of the control terminal of the driving circuit 100 and the potential of the second terminal 100b of the driving circuit in other working stages, so as to realize the compensation of the threshold voltage of the driving transistor.

In the pixel circuit 10 of FIG. 1, the first terminal 600a of the first light emission control circuit 600, the first terminal 100a of the driving circuit 100 and the second terminal 800b of the first compensation circuit 800 are electrically connected to a first node N1; the control terminal 100m of the driving circuit 100, the first terminal 800a of the first compensation circuit 800 and the first terminal 900a of the second compensation circuit 900 are electrically connected to a second node N2. For example, the first electrode plate of the compensation capacitor of the second compensation circuit 900 is electrically connected to the second node N2, and the first electrode plate of the compensation capacitor and the second node N2 can be directly connected, that is, there is no switching element between the first electrode plate of the compensation capacitor and the second node N2, and the first electrode plate of the compensation capacitor and the second node N2 can also be electrically connected through switching elements, such as transistors. The second terminal 100b of the driving circuit 100, the second terminal 900b of the second compensation circuit 900 and the first terminal 700a of the second light emission control circuit 700 are electrically connected to a third node N3, for example, the second electrode plate of the compensation capacitor of the second compensation circuit 900 is electrically connected to the third node N3, for example, the second electrode plate of the compensation capacitor is directly electrically connected to the third node N3, that is, there is no switching element between the second electrode plate and the third node N3; the first electrode 400a of the light emitting element 400, the second terminal 700b of the second light emission control circuit 700 and the first terminal 500a of the second reset circuit are electrically connected to a fourth node N4.

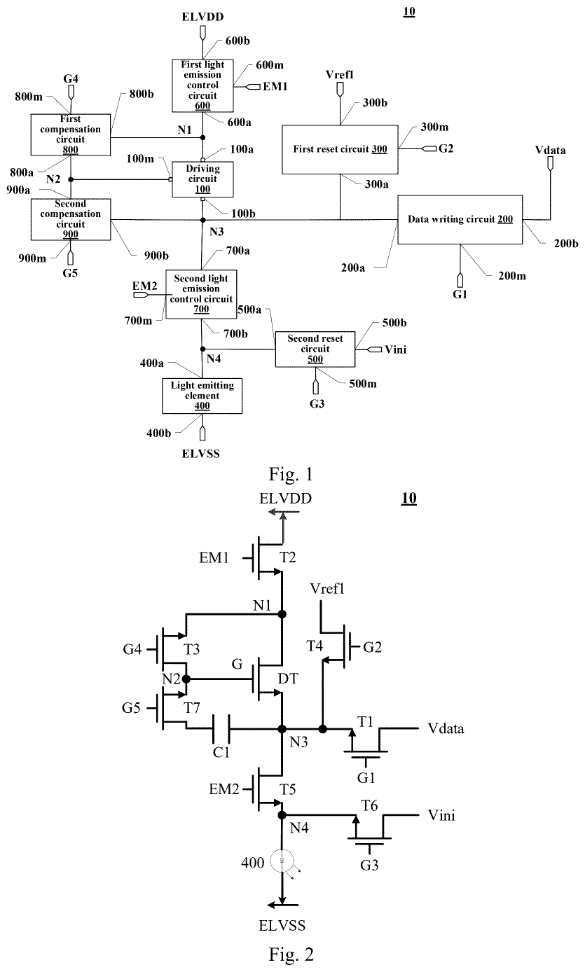

FIG. 2 is a circuit diagram of a specific example of the pixel circuit shown in FIG. 1. As illustrated by FIG. 2, the pixel circuit 10 includes a driving transistor DT, a data writing transistor T1, a first compensation transistor T3, a second compensation transistor T7, a first reset transistor T4, a second reset transistor T6, a first light emission control transistor T2, a second light emission control transistor T5, a compensation capacitor C1 and a light emitting element 400, for example, the light emitting element 400 can be an organic light emitting diode (OLED). For example, the data writing transistor T1, the first compensation transistor T3, the second compensation transistor T7, the first reset transistor T4, the second reset transistor T6, the first light emission control transistor T2 and the second light emission control transistor T5 are used as switching transistors. For example, the embodiment of the present disclosure takes the light emitting element as an OLED as an example, but is not limited thereto. For example, other light emitting elements can also be used as the light emitting element, which is not limited by the embodiment of the present disclosure. For example, when the light emitting element is an OLED, the light emitting element can be of various types, such as top emission, bottom emission, etc., for example, the light emitting element can emit red light, green light, blue light or white light, etc., which is not limited by the embodiment of the present disclosure.

For example, as illustrated by FIGS. 1 and 2, the driving circuit 100 includes a driving transistor DT, a gate electrode of the driving transistor DT serves as a control terminal 100m of the driving circuit 100, a first electrode of the driving transistor DT serves as a first terminal 100a of the driving circuit 100, and a second electrode of the driving transistor DT serves as a second terminal 100b of the driving circuit 100, and the first terminal 100a of the driving circuit 100 is electrically connected with a first power supply voltage terminal ELVDD to receive a first power supply voltage VDD.

For example, as illustrated by FIGS. 1 and 2, the data writing circuit 200 includes a data writing transistor T1, a gate electrode of the data writing transistor T1 is configured to be connected with a data scanning signal terminal to receive a data scanning signal G1, a first electrode of the data writing transistor T1 is electrically connected with the second terminal 100b of the driving circuit 100, that is, first electrode of the data writing transistor T1 is electrically connected with the second electrode of the driving transistor DT, a second electrode of the data writing transistor T1 is electrically connected with a data signal Vdata terminal to receive a data signal Vdata. The data writing transistor T1 is configured to write the data signal Vdata to the second electrode of the driving transistor DT in response to the data scanning signal G1 in the data writing stage.

For example, as illustrated by FIGS. 1 and 2, the first compensation circuit 800 includes a first compensation transistor T3, a gate electrode of the first compensation transistor T3 receives the first compensation control signal G4, a first electrode of the first compensation transistor T3 is electrically connected with the first electrode of the driving transistor DT, and a second electrode of the first compensation transistor T3 is electrically connected with the gate electrode of the driving transistor DT. Therefore, by controlling the turn-on and turn-off of the first compensation transistor T3 through the first compensation control signal G4, it is possible to control the control terminal 100m of the driving circuit 100 and the first terminal 100a of the driving circuit 100 whether to be electrically conducted or not.

For example, as illustrated by FIGS. 1 and 2, the first reset circuit 300 includes a first reset transistor T4 whose gate is electrically connected with the first reset control terminal to receive the first reset control signal G2, whose first electrode is electrically connected with the second terminal 100b of the driving circuit 100, that is, the second electrode of the driving transistor DT, and whose second electrode is electrically connected with the first reset signal terminal Vref1 to receive the first reset signal Vref1. The first reset transistor T4 is configured to write the first reset signal Vref1 to the second electrode of the driving transistor DT in response to the first reset control signal G2.

For example, in the pixel circuit shown in FIG. 2, the data writing transistor T1 and the first reset transistor T4 are independent and different transistors, and the data signal terminal Vdata and the first reset signal terminal Vref1 are independent and different signal terminals.

For example, as illustrated by FIGS. 1 and 2, the second reset circuit 500 includes a second reset transistor T6. A gate electrode of the second reset transistor T6 is electrically connected with a second reset control terminal to receive a second reset control signal G3; a first electrode of the second reset transistor T6 is electrically connected with the second terminal 100b of the driving circuit 100, for example, the first electrode of the second reset transistor T6 is electrically connected with the second electrode of the driving transistor DT; a second electrode of the second reset transistor T6 is electrically connected with the second reset signal terminal Vini to receive the second reset signal Vini. For example, the first electrode of the second reset transistor T6 is electrically connected with the second terminal 100b of the driving circuit 100 through the second light emission control circuit 700; alternatively, in other embodiments, the first electrode of the second reset transistor T6 and the second terminal 100b of the driving circuit 100 may be directly electrically connected.

For example, in the pixel circuit 10 shown in FIG. 2, the second reset transistor T6 and the first reset transistor T4 are independent and different transistors, and the first reset signal terminal Vref1 and the second reset signal terminal Vini are independent and different signal terminals.

For example, as illustrated by FIGS. 1 and 2, the second compensation circuit 900 further includes a second compensation transistor T7, a gate electrode of the second compensation transistor T7 receives a second compensation control signal G5, a first electrode of the second compensation transistor T7 is electrically connected with the gate electrode of the driving transistor DT, and a second electrode of the second compensation transistor T7 is electrically connected with the first electrode plate of the compensation capacitor C1 so that the first electrode plate of the compensation capacitor C1 is electrically connected with the gate electrode of the driving transistor DT through the second compensation transistor T7. In this way, the turn-on and turn-off of the second compensation transistor T7 can be controlled by the second compensation control signal G5; thus, the second compensation transistor T7 can be turned on in a specific working stage, so that the compensation capacitor C1 can play a bootstrap role to adjust the potential of the gate electrode of the driving transistor DT, or the second compensation transistor T7 can be turned off in a specific working stage, so that the potential of the gate electrode of the driving transistor DT can be maintained, and will not change due to the change of the potential applied to the second electrode plate of the compensation capacitor C1, that is, the potential of the gate electrode of the driving transistor DT will not change in response to the potential change of the second electrode of the driving transistor DT, so that the threshold voltage can be compensated.

For example, a second electrode plate of the compensation capacitor C1 is directly connected with the second electrode of the second compensation transistor T7, that is, there is no other switching element between the second electrode plate of the compensation capacitor C1 and the second electrode of the second compensation transistor T7, so as to realize the compensation of the threshold voltage of the driving circuit by adopting the simplest structure, but the present disclosure is certainly not limited thereto. The switching element here can be, for example, any switching element that can be controlled to be turned on and off as required, such as a transistor.

For example, as illustrated by FIGS. 1 and 2, the first light emission control circuit 600 includes a first light emission control transistor T2, a gate electrode of first light emission control transistor T2 is electrically connected with a first light emission control terminal EM1 to receive the first light emission control signal EM1, a first electrode of the first light emission control transistor T2 is electrically connected with the first terminal 100a of the driving circuit 100, that is, the first electrode of the driving transistor DT, and a second electrode of first light emission control transistor T2 is electrically connected with a first voltage terminal ELVDD to receive a first power supply voltage VDD.

For example, as illustrated by FIGS. 1 and 2, the second light emission control circuit 700 includes a second light emission control transistor T5, a gate electrode of the second light emission control transistor T5 is electrically connected a the second light emission control terminal EM2 to receive a second light emission control signal EM2, a first electrode of the second light emission control transistor T5 is electrically connected with the second terminal 100b of the driving circuit 100, that is, the second electrode of the driving transistor DT, a second electrode of the second light emission control transistor T5 is electrically connected with the first electrode of the light emitting element 400. For example, the first electrode of the second reset transistor T6 is electrically connected with the second electrode of the second light emission control transistor T5, so that the first electrode of the second reset transistor T6 can be electrically connected with the second terminal 100b of the driving circuit 100 through the second light emission control transistor T5.

In the pixel circuit 10 shown in FIG. 2, the first electrode of the first compensation transistor T3, the first electrode of the driving transistor DT and the first electrode of the first light emission control transistor T2 are connected to a first node N1; the gate electrode of the driving transistor DT, the second electrode of the first compensation transistor T3 and the first electrode of the second compensation transistor T7 are connected to a second node N2; the second electrode of the driving transistor DT, the second electrode plate of the compensation capacitor C1 and the first electrode of the second light emission control transistor T5, the first electrode of the data writing transistor T1 and the first electrode of the first reset transistor T4 are electrically connected to a third node N3; the first electrode of the second reset transistor T6, the second electrode of the second light emission control transistor T5 and the first electrode of the light emitting element 400 are electrically connected to a fourth node N4.

It should be noted that, in various embodiments of the present disclosure, the first node N1, the second node N2, the third node N3 and the fourth node N4 do not necessarily represent the actual components, but represent the meeting points of related circuit connections in the circuit diagram. In the description of the embodiment of the present disclosure, the symbol Vdata can represent both the data signal terminal and the data signal; Similarly, the symbol Vref1 can represent both the first reset control signal terminal and the first reset control signal; the symbol Vini can represent both the second reset signal terminal and the second reset signal; the symbol Vref2 can represent both the third reset signal terminal and the third reset signal; the symbol EM1 can represent both the first light emission control terminal and the first light emission control signal; the symbol EM2 can represent both the second light emission control terminal and the second light emission control signal; the symbol G1 can represent both the data scanning signal terminal and the data scanning signal, the symbol G2 can represent both the first reset control terminal and the first reset control signal, the symbol G3 can represent both the second reset control terminal and the second reset control signal, the symbol G4 can represent both the second reset control terminal and the second reset control signal, the symbol G5 can represent both the second compensation control terminal and the second compensation control signal, and the symbol G6 can represent the third reset control signal terminal and the third reset control signal.

It should be noted that the transistors used in the embodiments of the present disclosure can all be thin film transistors, field effect transistors or other switching elements with the same characteristics, and the embodiments of the present disclosure all take thin film transistors as examples to explain. A source electrode and a drain electrode of the transistor used here can be symmetrical in structure, so there can be no difference in structure between the source electrode and the drain electrode. In the embodiment of the present disclosure, in order to distinguish the two electrodes of the transistor except the gate electrode, one of the source electrode and the drain electrode is directly described as a first electrode and the other the source electrode and the drain electrode is described as the second electrode.

In addition, transistors can be divided into N-type transistors and P-type transistors according to their characteristics. When the transistor is a P-type transistor, the turn-on voltage is a low-level voltage (for example, 0V, −5V, −10V or other suitable voltage) and the turn-off voltage is a high-level voltage (for example, 5V, 10V or other suitable voltage); when the transistor is an N-type transistor, the turn-on voltage is a high-level voltage (for example, 5V, 10V or other suitable voltage) and the turn-off voltage is a low-level voltage (for example, 0V, −5V, −10V or other suitable voltage). However, the embodiment of the present disclosure does not limit the types of transistors, and when the types of transistors change, the connection relationship in the circuit can be adjusted accordingly.

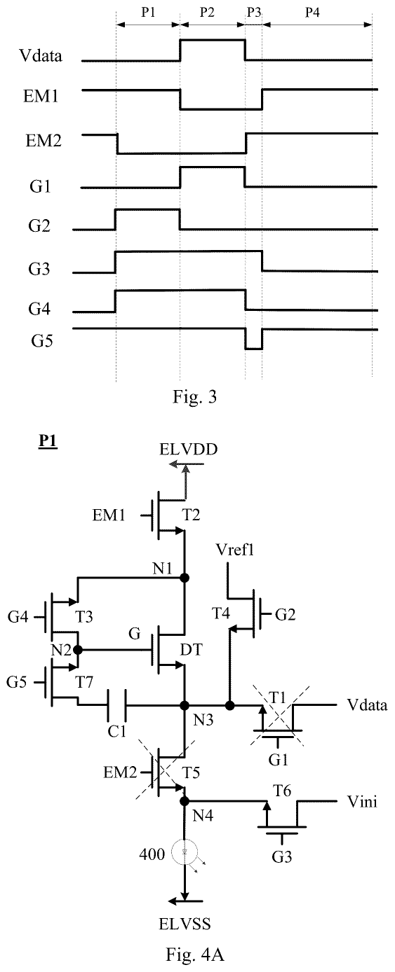

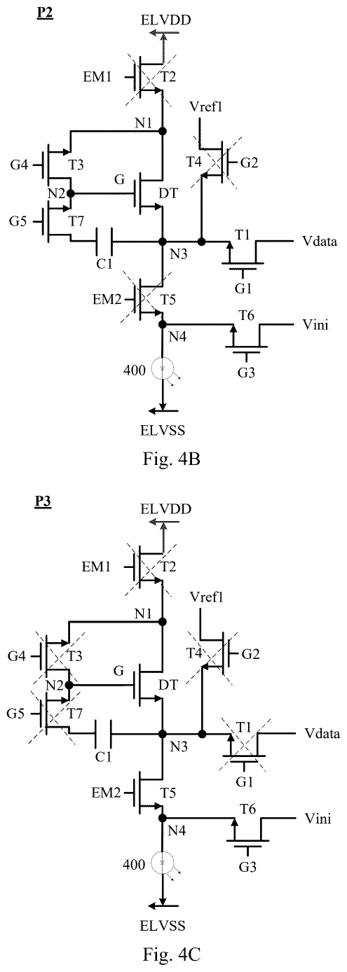

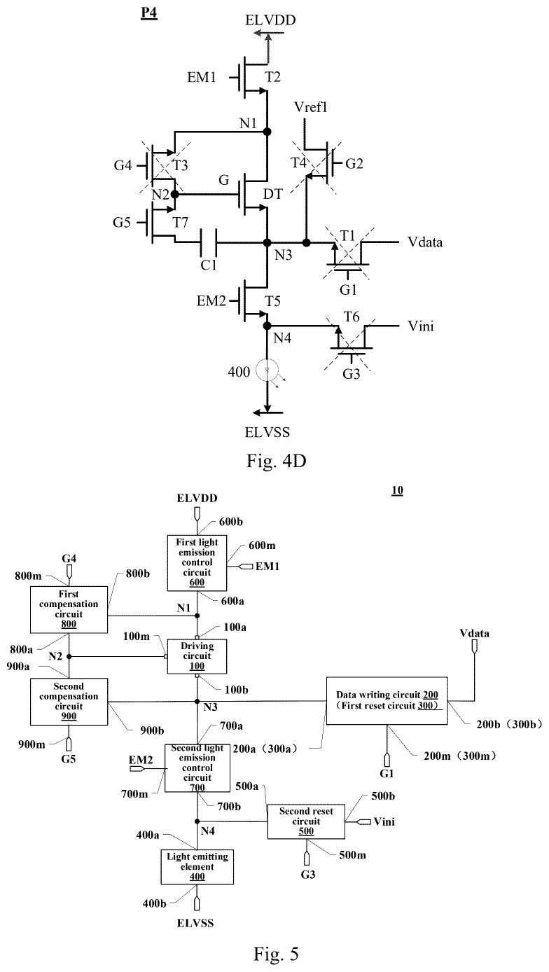

The working process of the pixel circuit 10 shown in FIG. 2 will be described with reference to the signal timing diagram shown in FIG. 3 and FIGS. 4A-4D. As illustrated by FIG. 3, the display process of each frame image includes four stages, namely an initial stage P1, a data writing stage P2, a compensation stage P3 and a light emitting stage P4.

FIG. 4A is a schematic diagram of the pixel circuit 10 shown in FIG. 2 in an initial stage; FIG. 4B is a schematic diagram of the pixel circuit 10 shown in FIG. 2 in a data writing stage; FIG. 4C is a schematic diagram of the pixel circuit 10 shown in FIG. 2 in the compensation stage; FIG. 4D is a schematic diagram of the pixel circuit 10 shown in FIG. 2 in the light emitting stage. In addition, the transistors marked with dashed lines in FIGS. 4A-4D all indicate that they are in off state (i.e., turn-off state) in the corresponding stage, and the transistors not marked with dashed lines are in on state (i.e., turn-on state) in the corresponding stage.

For example, in the pixel circuit 10 shown in FIG. 2, the driving transistor DT, the data writing transistor T1, the first compensation transistor T3, the second compensation transistor T7, the first reset transistor T4, the second reset transistor T6, the first light emission control transistor T2, and the second light emission control transistor T5 are all N-type transistors, that is, each transistor is turned on when the gate electrode thereof is connected with a high-level signal, and turned off when the gate electrode thereof is connected with a low-level signal. Of course, in other embodiments, these transistors may all be P-type transistors, or some of the transistors may be P-type transistors, and the other of the transistors may be N-type transistors, as long as the designed turn-on signal or turn-off signal is controlled for each transistor in the corresponding stage during the operation of the pixel circuit.

As illustrated by FIG. 1 and FIG. 3, an embodiment of the present disclosure provides a driving method of a pixel circuit, the driving method is suitable for the pixel circuit provided by the embodiment of the present disclosure. The driving method of the pixel circuit includes: in a data writing stage P2, setting the data scanning signal G1 as a turn-on signal, to turn on the data writing circuit 200, and the data signal Vdata is written to the second terminal 100b of the driving circuit 100 through the data writing circuit 200, and, controlling the first compensation circuit 800 and the second compensation circuit 900 to allow the potential of the control terminal 100m of the driving circuit 100 change in response to the potential change of the second terminal 100b of the driving circuit 100; and in a compensation stage after the data writing stage P2, controlling the first compensation circuit 800 and the second compensation circuit 900 to maintain the potential of the control terminal 100m of the driving circuit 100, not allow the potential of the control terminal 100m of the driving circuit 100 to change in response to the potential change of the second terminal 100b of the driving circuit 100.

For example, the driving method of the pixel circuit further includes: in the initial stage P1, turning on the first compensation circuit 800, and the first power supply voltage VDD is applied to the driving terminal of the driving circuit 100 sequentially passing through the first terminal 100a of the driving circuit 100 and the first compensation circuit 800, to allow the driving circuit 100 to be conductive, that is, the first terminal 100a and the second terminal 100b of the driving circuit 100 are conducted.

For example, the driving method of the pixel circuit further includes: in the initial stage P1, setting the first light emission control signal EM1 as a turn-on signal to turn on the first light emission control circuit 600, and the first power supply voltage VDD is written to the first terminal 100a of the driving circuit 100 through the first light emission control circuit 600.

For example, the driving method of the pixel circuit further includes: in the initial stage P1, setting the first reset control signal G2, the second reset control signal G3 and the first compensation control signal G4 as turn-on signals, so that the first reset circuit 300 is turned on, so that the first reset signal Vref1 is applied to the second terminal 100b of the driving circuit 100 through the first reset circuit 300, and the second reset circuit 500 is turned on, so that the second reset signal Vinit is applied to the first electrode 400a of the light emitting element 400 through the second reset circuit 500, so as to accomplish the reset of various positions. Moreover, applying the second reset signal Vini to the first electrode 400a of the light emitting element 400 in the initial stage PI can ensure that the potential of the first electrode 400a of the light emitting element 400 can be kept as Vini in the subsequent data writing stage and compensation stage without turning on the second reset circuit, that is, without writing the second reset signal Vini, so as to meet the compensation calculation of the threshold voltage and simplify the driving method.

For example, the driving method of the pixel circuit further includes: in the data writing stage P2, setting the first compensation control signal G4 as a turn-on signal, so that the first compensation circuit 800 is turned on in response to the first compensation control signal G4, and the control terminal 100m of the driving circuit 100 and the first terminal 100a of the driving circuit 100 are conducted through the first compensation circuit 800, the potential of the first power supply voltage VDD input to the control terminal 100m of the driving circuit 100 is higher than the potential of the data signal Vdata written to the third node N3 in the data writing stage P2, so that, in the data writing stage P2, the control terminal 100m of the driving circuit 100 discharges to the third node N3 through the first compensation circuit 800 and the driving circuit 100, so as to generate a compensation current between the control terminal 100m of the driving circuit 100 and the second terminal 100b of the driving circuit 100, and the compensation current flows through the first compensation circuit 800 and the driving circuit 100, so that the potential of the control terminal 100m of the driving circuit 100 changes in response to the potential change of the second terminal 100b of the driving circuit 100 until the potential of the second terminal 100b of the driving circuit 100 reaches to turn off the driving circuit 100. That is, the potential of the control terminal 100m of the driving circuit 100 changes in response to the potential change of the second terminal 100b of the driving circuit 100 until the driving circuit 100 is turned off, for example, until the driving transistor DT is turned off. At the end of the data writing stage P2, the potential V_{G} of the control terminal 100m of the driving circuit 100 satisfies V_{G}=Vdata+Vth.

For example, the control method of the pixel circuit further includes: in the compensation stage P3, setting at least the first compensation control signal G4 as a turned turn-off signal to turn off the first compensation circuit 800, so that no current is allowed to be generated between the control terminal 100m of the driving circuit 100 and the second terminal 100b of the driving circuit 100, and the potential of the control terminal 100m of the driving circuit 100 is maintained unchanged, and is not allowed to change in response to the potential change of the second terminal 100b of the driving circuit 100.

For example, the driving method of the pixel circuit further includes: in the light emitting stage P4 after the compensation stage P3, setting the first light emission control signal EM1 and the second light emission control signal EM2 as turn-on signals and the data scanning signal G1, the first reset control signal G2, the second reset control signal G3 and the first compensation control signal G4 as turn-off signals, so that the first light emission control circuit 600 and the second light emission control circuit 700 are both turned on, and the data writing circuit 200, the first reset circuit 300, the second reset circuit 500 and the first compensation circuit 800 are all turned off, thereby forming a driving current flowing through the first light emission control circuit 600, the driving circuit 100, the second light emission control circuit 700 and the light emitting element 400. After the above four stages, the compensation of the threshold voltage of the driving circuit 100 (that is, the threshold voltage of the driving transistor DT of the driving circuit 100) is completed in the light emitting stage, and the driving current is independent of the threshold voltage of the driving circuit 100, so that the problem of uneven brightness of pixels using the pixel circuit caused by unstable threshold voltage does not exist, and the light emitting uniformity of pixels driven by the pixel circuit 10 is improved.

Specifically, the driving method of the pixel circuit of FIG. 2 and the compensation principle for the threshold voltage shown in FIGS. 4A-4D will be described below.

Referring to FIGS. 4A and 3, the control method of the pixel circuit further includes the following steps in the initial stage P1. In the initial stage P1, the first light emission control signal EM1, the first reset control signal G2, the second reset control signal G3, the first compensation control signal G4 and the second compensation control signal G5 are all turn-on signals, for example, all at high level, so that the first light emission control transistor T2, the first reset transistor T4, the second reset transistor T6, the first compensation transistor T3 and the second compensation transistor T7 are turned on, and the second light emission control signal EM2 and the data scanning signal G1 are all turn-off signals, for example, all at low level, so that the second light emission transistor T5 and the data writing transistor T1 are turned off. Therefore, in the initial stage P1, the first power supply voltage VDD is written to the gate electrode G of the driving transistor DT sequentially passing through the first light emission control transistor T2 and the first compensation transistor T3, so that the driving transistor DT is turned on, so that the first power supply voltage VDD is written to the first node N1 sequentially passing through the first light emission control transistor T2 and the driving transistor DT, and the first reset voltage Vref1 is written to the third node N3 through the first reset transistor T4, and the second reset voltage Vini is written to the fourth node N4 through the second reset transistor T6, thus completing the setting of the potential of the required nodes.

Referring to FIGS. 4B and 3, the control method of the pixel circuit further includes the following steps in the data writing stage P2. In the data writing stage P2, the data scanning signal G1 is a turn-on signal, for example, a high level signal, so that the data writing transistor T1 is turned on. Moreover, both the first compensation control signal G4 and the second compensation control signal G5 are turn-on signals, such as high level signals, so that both the first compensation transistor T3 and the second compensation transistor T7 remain on. The potential of the first power supply voltage VDDA written to the gate electrode G of the driving transistor DT in the initial stage P1 is higher than the potential of the data signal Vdata written to the third node N3 in the data writing stage P2, so that the gate electrode G of the driving transistor DT discharges to the third node N3 through the first compensation transistor T3 and the driving transistor DT in sequence in the data writing stage P2, to generate a compensation current between the driving transistor DT and the second electrode of the driving transistor DT, and the compensation current flows through the first compensation transistor T3 and the driving transistor DT, that is, the potential of the gate electrode G of the driving transistor DT changes in response to the change of the potential of the second electrode of the driving transistor DT until the driving transistor DT is turned off, for example, until the driving transistor DT is just turned off, so that the gate-source voltage of the driving transistor DT is V_{GS}=Vth, that is, V_{G}−V_{N3}=Vth, because V_{N3}=Vdata at this time, V_{G}=Vdata+Vth. In this way, at the end of the data writing stage P2, the potential V_{G} of the gate electrode G of the driving transistor DT satisfies V_{G}=Vdata+Vth, and V_{G} participates in the compensation calculation to cooperate with the control of the potential of the control terminal of the driving circuit 100 and the potential of the second terminal 100b of the driving circuit in other working stages to realize the compensation of the threshold voltage of the driving transistor. Moreover, in the above process of data writing stage P2, because the second compensation transistor T7 and the compensation capacitor C1 are provided and the second compensation transistor T7 is turned on, information such as the threshold voltage Vth of the driving transistor DT is stored in the compensation capacitor C1, thereby completing the data writing process.

For example, the data signal Vdata is a data voltage, and the first power supply voltage VDD written in the initial stage P1 is higher than the data voltage written in the data writing stage P2, so that the gate electrode G of the driving transistor DT can discharge to the third node N3 through the first compensation transistor T3 and the driving transistor DT in sequence in the data writing stage P2.

For example, in the embodiment shown in FIG. 3, in the data writing stage P2, the second reset control signal G3 is also a turn-on signal, for example, a high level signal, so as to turn on the second reset transistor T6 and continue to write the second reset signal Vini to the fourth node N4; alternatively, in other embodiments, for the pixel circuit 10 shown in FIG. 2, in the data writing stage P2, the second reset control signal G3 may also be a turn-off signal to stop writing the second reset signal Vini to the fourth node N4, because the second light emission control transistor T5 is turned off at this time, and the signal of the fourth node N4 will not affect the potential of the second electrode of the driving transistor DT and the potential of the gate electrode G of the driving transistor DT.

Referring to FIGS. 4C and 3, the control method of the pixel circuit further includes the following steps in the compensation stage P3. In the compensation stage P3, both the first compensation control signal G4 and the second compensation control signal G5 are turn-off signals, for example, both at low level, so that both the first compensation transistor T3 and the second compensation transistor T7 are turned off, so that the gate electrode G of the driving transistor DT cannot discharge through the first compensation transistor T3 or the second compensation transistor T7 to maintain the potential of the control terminal 100m of the driving circuit 100 unchanged, that is, to maintain the potential of the gate electrode G of the driving transistor DT unchanged, and the potential of the control terminal 100m of the driving circuit 100 is maintained at the potential at the end of the data writing stage P2. For example, in the compensation stage P3, the first light emission control signal EM1, the data scanning signal G1 and the first reset control signal G2 are all turn-off signals, such as low level signals, so that the first light emission control transistor T2, the data transistor T1 and the first reset transistor T4 are all turned off; moreover, in the compensation stage P3, the second light emission control signal EM2 and the second reset control signal G3 are both turn-on signals, for example, both at high level, so that the second light emission control circuit 700 and the second reset circuit 500 are both turned on, that is, the second reset signal Vini is written to the second terminal 100b of the driving circuit 100 through the second light emission control circuit 700, so that the potential V_{N3} of the second terminal 100b of the driving circuit 100 satisfies V_{N3}=Vini. Besides, the potential of the gate electrode G of the driving transistor DT is maintained at the potential at the end of the data writing stage P2. Specifically, both the second light emission control transistor T5 and the second reset transistor T6 are turned on, so that the second reset signal Vini is written to the second electrode of the driving transistor DT through the second light emission control transistor T5 so that the potential V_{N3} of the second electrode of the driving transistor DT becomes V_{N3}=Vini, that is, the potential of the second electrode plate of the compensation capacitor C1 becomes Vini, that is, the potential V_{N3} of the third node N3 satisfies V_{N3}-Vini, and the potential of the gate electrode G of the driving transistor DT is maintained at the potential at the end of the data writing stage P2, so that the potential of the third node N3 and the potential of the gate electrode G of the driving transistor DT at this moment are used to participate in the compensation calculation of the threshold voltage of the driving transistor DT. Of course, for example, in other embodiments, the second reset control signal G3 can also be a turn-off signal in the compensation stage, because the second reset signal Vini has been written to the fourth node N4 in the initial stage P1, so that the potential V_{N3} of the third node N3 can satisfy V_{N3}=Vini even if the second reset signal vini is not rewritten when the second light emission control transistor T5 is turned on in the compensation stage.

Referring to FIGS. 4D and 3, the control method of the pixel circuit further includes the following steps in the light emitting stage P4 after the compensation stage P3. In the light emitting stage P4, setting the second compensation control signal G5 as a turned-on signal, for example, a high level signal, so that the second compensation control transistor T7 is turned on, so that the compensation capacitor C1 can play a bootstrap role to change the potentials of the gate electrode G of the driving transistor DT electrically connected with the first electrode plate of the compensation capacitor C1 and the third node N3 electrically connected with the second electrode plate of the compensation capacitor C1 by the same amount, thereby realizing the compensation for the threshold voltage of the driving transistor DT. For example, for the pixel circuit 10 shown in FIG. 2, in the light emitting stage P4, the first light emission control signal EM1 and the second light emission control signal EM2 are also turn-on signals, such as high level signals, so that the first light emission control transistor T2 and the second light emission control transistor T5 are turned on, and the data scanning signal G1, the first reset control signal G2, the second reset control signal G3 and the first compensation control signal G4 are all turn-off signals, for example, at low level, so that the data writing transistor T1, the first reset transistor T4, the second reset transistor T6 and the first compensation transistor T3 are all turned off, and finally the driving transistor DT is turned on, the first power supply voltage VDD is applied to the first electrode of the driving transistor DT, and the driving current is applied to the light emitting element 400 through the second light emission control transistor T5 to make the light emitting element emit light.

In the light emitting stage P4, because the light emitting element 400 is in a light emitting state, the voltage value of the first electrode of the light emitting element 400 (i.e., the voltage value of the fourth node N4) and the voltage value of the second electrode of the driving transistor DT all correspond to the voltage value Voled when the light emitting element 400 emits light, i.e., the voltage value of the first electrode of the light emitting element 400 (i.e., the fourth node N4) is Voled; because the second light emission control circuit 700 is turned on, the voltage value of the second electrode plate of the compensation capacitor C1 is also Voled at this moment, so the change amount of the voltage value of the second electrode plate of the compensation capacitor C1 is ΔV_{N3}=Voled−Vini. Accordingly, the compensation capacitor C1 plays a bootstrap role, so that the first electrode plate of the compensation capacitor C1 also has a variation A VN3=Voled-Vini, thereby making the voltage value of the gate electrode G of the driving transistor DT (the voltage value of the second node N2) have a variation Δ V_{N3}, and the voltage value of the gate electrode G of the driving transistor DT is represented by V_{G}, so V_{G}=Vdata+Vth+Voled−Vini. The driving transistor DT is in the turn-on state, and the gate-source voltage of the driving transistor DT is represented by V_{GS}, so V_{GS}=V_{G}−V_{N3}=(Vdata+Vth+Voled−Vini)−Voled=Vdata+Vth−Vini.

The value I of the driving current flowing through the light emitting element can be obtained according to the following formula:

I=K×(V_{GS}−Vth)²,

where k is the conductivity of the driving transistor DT. Namely:

$$I = K * {( Vdata - Vini )}^{2}$$

According to the above formula, the value I of the driving current flowing through the light emitting element is no longer related to the threshold voltage Vth of the driving transistor DT, so that the compensation for the pixel circuit can be realized, the problem that the threshold voltage Vth of the driving transistor DT drifts due to the process and long-term operation can be solved, and the influence on the driving current can be eliminated, so that the display effect of the display device adopting the pixel circuit can be improved.

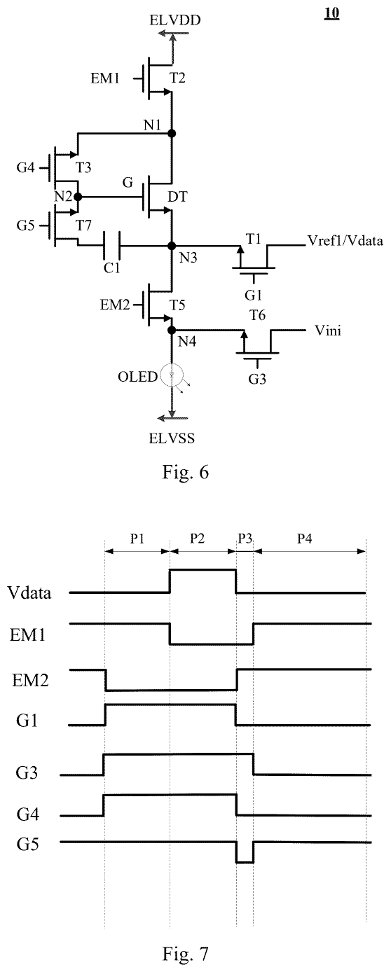

FIG. 5 is a schematic block diagram of another pixel circuit provided by at least one embodiment of the present disclosure; FIG. 6 is a circuit diagram of a specific example of the pixel circuit shown in FIG. 5; FIG. 7 is a signal timing diagram of a driving method of the pixel circuit shown in FIGS. 5-6 provided by at least one embodiment of the present disclosure. The structure and driving method of the pixel circuit shown in FIGS. 5-7 are different from those of the pixel circuit shown in FIGS. 1-3 as follows.

Referring to FIG. 5, the data writing circuit 200 also serves as a first reset circuit 300. For example, referring to FIG. 6, the data writing transistor T1 also serves as a first reset transistor; the data scanning signal G1 also serves as a first reset control signal, and the data signal terminal Vdata also serves as a first reset signal terminal Vref1, and is configured to receive a data signal Vdata and a first reset signal Vref1 at different time periods, respectively.

For example, in the initial stage P1 and the data writing stage P2, the data scanning signal G1 is a turn-on signal to turn on the data writing circuit 200, for example, the data writing transistor T1 is kept on, and the data signal terminal Vdata receives the first reset signal Vref1 in the initial stage P1 and the data signal Vdata in the data writing stage P2.

Specifically, referring to FIGS. 5 and 7, in the initial stage P1, the data scanning signal G1 is a turn-on signal to turn on the data writing circuit 200, the data writing circuit 200 is used as the first reset circuit 300, and the data signal terminal Vdata receives the first reset signal Vref1, the first reset signal Vref1 is applied to the second terminal 100b of the driving circuit 100 through the data writing circuit 200. For example, for the pixel circuit shown in FIG. 6, in the initial stage P1, the data scanning signal G1 is a turn-on signal to turn on the data writing transistor T1, the data writing transistor T1 serves as a first reset transistor, and the data signal terminal Vref1 receives the first reset signal Vref1, and the first reset signal Vref1 is applied to the second electrode of the driving transistor DT, that is, to the third node N3 through the data writing transistor T1.

Referring to FIGS. 5 and 7, in the data writing stage P2, the data scanning signal G1 is a turn-on signal to turn on the data writing circuit 200, and the data signal terminal Vref1 receives the data signal Vdata, and the data signal Vdata is written to the second terminal 100b of the driving circuit 100 through the data writing circuit 200. For example, in the pixel circuit shown in FIG. 6, in the data writing stage P2, the data scanning signal G1 is a turn-on signal to turn on the data writing transistor T1, and the data signal terminal Vdata receives the data signal Vdata, and the data signal Vdata is written to the second electrode of the driving transistor DT, that is, the third node N3, through the data writing transistor T1.

Other signals and working processes in the initial stage P1 and data writing stage P2 are the same as those in the pixel circuit shown in FIGS. 1-3, and the working processes in the subsequent compensation stage and light emitting stage are also the same as those in the pixel circuit shown in FIGS. 1-3. Other unmentioned structures, other working processes and compensation principles of the pixel circuit and its driving method shown in FIGS. 5-7 are the same as those of the pixel circuit shown in FIGS. 1-3. Please refer to the previous description and the repeated portions are omitted here.

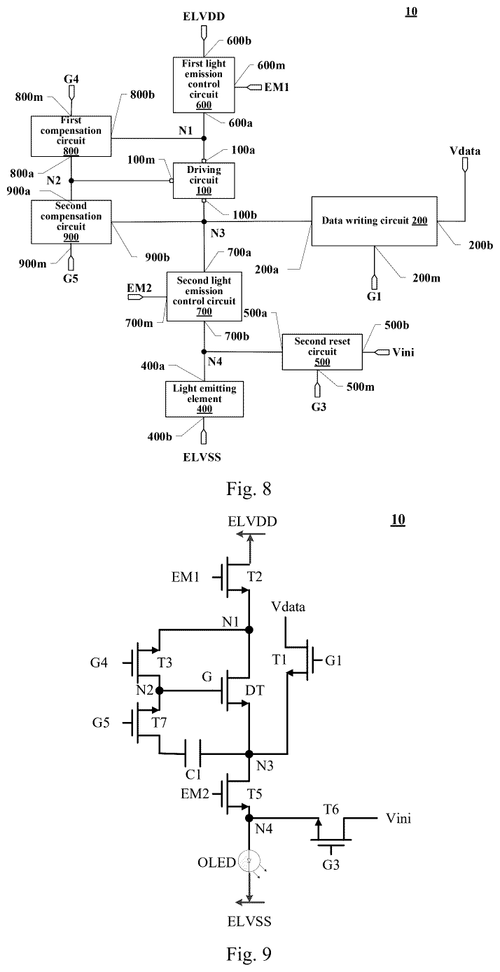

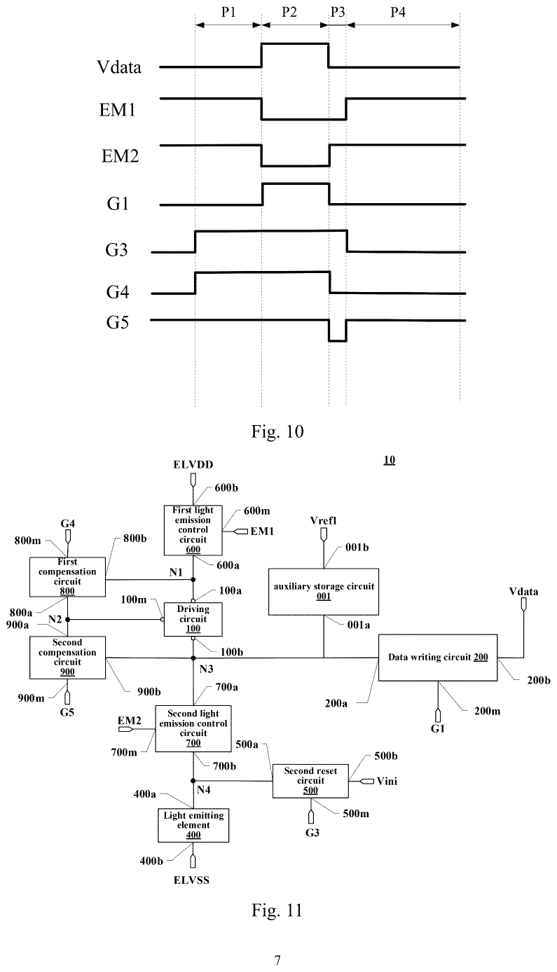

FIG. 8 is a schematic block diagram of another pixel circuit provided by at least one embodiment of the present disclosure; FIG. 9 is a circuit diagram of a specific example of the pixel circuit shown in FIG. 8; FIG. 10 is a signal timing diagram of a driving method of the pixel circuit shown in FIGS. 8-10 provided by at least one embodiment of the present disclosure. The structure and driving method of the pixel circuit shown in FIGS. 8-10 are different from those of the pixel circuit shown in FIGS. 1-3.

Compared with the pixel circuit shown in FIGS. 1-2, in the pixel circuit 10 shown in FIGS. 8-9, the first reset circuit 300 is removed.

For the pixel circuit 10 and its driving method shown in FIGS. 8-9, the method of resetting the third node N3 in the initial stage P1 is different from that shown in FIGS. 1-3. Referring to FIGS. 8 and 9, in the initial stage P1, the second light emission control signal EM2 is a turn-on signal to turn on the second light emission control circuit 700, and the second reset control signal G3 is a turn-on signal to turn on the second reset circuit 500, so that the second reset signal Vini is applied to the first electrode 400a of the light emitting element 400, that is, the fourth node N4 through the second reset circuit 500. And then the second reset signal Vini is applied to the second terminal 100b of the driving circuit 100, that is, the third node N3, through the second light emission control circuit 700, thereby realizing the reset of various positions. For example, for the pixel circuit 10 shown in FIG. 9, in the initial stage P1, the second reset signal Vini is applied to the second electrode of the driving transistor DT, that is, the third node N3, through the turned-on second light emission control circuit 700, thereby completing the reset of the third node N3. The same or similar technical effects as those of the pixel circuits shown in FIGS. 1-2 can be achieved. During the operation of the pixel circuit, the potential of the third node N3 can be better maintained as the second reset voltage Vini in the initial stage P1 by using the characteristic that the voltages of the first electrode plate and the second electrode plate of the compensation capacitor C1 cannot be abruptly changed, and the potential of the third node N3 can be maintained as the second reset voltage Vinit in the initial stage P1; besides, the potential of the third node N3 can be prevented from jumping during the operation of the pixel circuit, thus avoiding the adverse influence of the potential jump of the third node N3 on the display uniformity and stability. Specifically, for example, at the end of the initial stage P1, the potential of the third node N3 is the second reset voltage Vini, when the data writing stage P2 is entered and the data signal Vdata is written to the third node N3 through the data writing circuit 200, the compensation capacitor C1 can be used to avoid the potential jump of the third node N3. Furthermore, at the end of the data writing stage P2, the data writing transistor T1 is turned off, and the potential jump of the third node N3 can also be avoided by using an auxiliary storage capacitor C2. Therefore, it is possible to at least avoid the potential jump of the third node N3 at these time nodes which are very easy to cause, prevent the potential jump of the third node N3, and improve the light emitting uniformity and stability of the pixel driven by the pixel circuit 10. Other unmentioned structures, other working processes and compensation principles of the pixel circuit and its driving method shown in FIGS. 8-9 are the same as those of the pixel circuit shown in FIGS. 1-3, so please refer to the previous description and the repeated portion are omitted here.

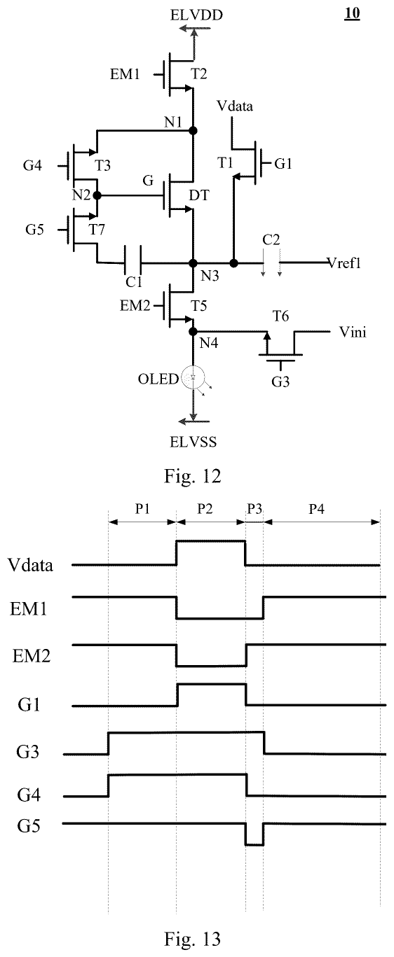

FIG. 11 is a schematic block diagram of another pixel circuit provided by at least one embodiment of the present disclosure; FIG. 12 is a circuit diagram of a specific example of the pixel circuit shown in FIG. 11; FIG. 13 is a signal timing diagram of a driving method of the pixel circuits shown in FIGS. 11 and 12 provided by at least one embodiment of the present disclosure. The structure and driving method of the pixel circuit shown in FIGS. 11-13 are different from those of the pixel circuit shown in FIGS. 8-9.

Referring to FIG. 11, for example, the pixel circuit 10 further includes an auxiliary storage circuit 001, a first terminal 001a of the auxiliary storage circuit 001 is electrically connected with the second terminal 100b of the driving circuit 100, a second terminal 100b of the auxiliary storage circuit 001 is electrically connected with the first reset signal terminal Vref1 to receive the first reset signal Vref1, and the auxiliary storage circuit 001 is configured to maintain the potential of the second terminal 100b of the driving circuit 100. Referring to FIGS. 8-9, the auxiliary storage circuit 001 includes an auxiliary storage capacitor C2, a first electrode plate of the auxiliary storage capacitor C2 is electrically connected with the second terminal 100b of the driving circuit 100, and a second electrode plate of the auxiliary storage capacitor C2 is electrically connected with the first reset signal terminal Vref1.

Referring to FIG. 11-FIG. 12, for example, the auxiliary storage circuit 001 includes an auxiliary storage capacitor C2, a first electrode plate of the auxiliary storage circuit 001 is electrically connected with the second electrode of the driving transistor DT, that is, to the third node N3, and a second electrode plate of the auxiliary storage circuit 001 is electrically connected with the first reset signal terminal Vref1. In this way, the auxiliary storage capacitor C can be used to avoid the potential jump of the third node N3, thus avoiding the adverse impact of the potential jump of the third node N3 on the display uniformity and stability.

As illustrated by FIG. 13, the driving method and timing of the pixel circuit may be the same as those of the pixel circuits shown in FIGS. 8-10. Referring to FIGS. 11 and 13, in the initial stage P1, the second light emission control signal EM2 is a turn-on signal to turn on the second light emission control circuit 700, and the second reset control signal G3 is a turn-on signal to turn on the second reset circuit 500, so that the second reset signal Vini is applied to the first electrode 400a of the light emitting element 400, that is, the fourth node N4 through the second reset circuit 500. And then the second reset signal Vini is applied to the second terminal 100b of the driving circuit 100, that is, the third node N3, through the second light emission control circuit 700, thereby realizing the reset of various positions. For example, for the pixel circuit 10 shown in FIG. 12, in the initial stage P1, the second reset signal Vini is applied to the second electrode of the driving transistor DT, that is, the third node N3 through the turned-on second light emission control circuit 700. During the operation of the pixel circuit 10, the voltage of the first electrode plate and the second electrode plate of the auxiliary storage capacitor C2 cannot be abruptly changed, so that the potential of the third node N3 can be better maintained as the second reset voltage Vini in the initial stage P1, and the voltage of the third node N3 can be prevented from jumping during the operation of the pixel circuit, thereby avoiding the adverse impact of the potential jump of the third node N3 on the display uniformity and stability. Specifically, for example, at the end of the initial stage P1, the potential of the third node N3 is the second reset voltage Vini. When entering the data writing stage P2 and writing the data signal Vdata to the third node N3 through the data writing circuit 200, the auxiliary storage capacitor C2 can be used to avoid the potential jump of the third node N3. Furthermore, at the end of the data writing stage P2, the data writing transistor T1 is turned off, and the potential jump of the third node N3 can also be avoided by using the auxiliary storage capacitor C2. Therefore, it is possible to at least avoid the potential jump of the third node N3 at these time nodes which are very easy to cause, prevent the potential jump of the third node N3, and improve the light emitting uniformity and stability of the pixel driven by the pixel circuit 10.

Other unmentioned structures, other working processes and compensation principles of the pixel circuit and its driving method shown in FIGS. 11-13 are the same as those of the pixel circuit shown in FIGS. 8-10, so please refer to the previous description and the repeated portions are omitted here.

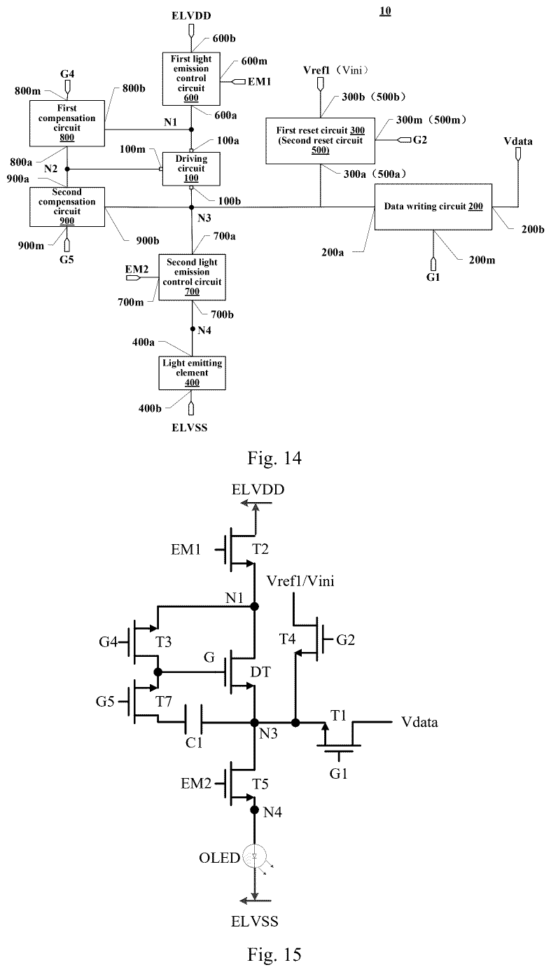

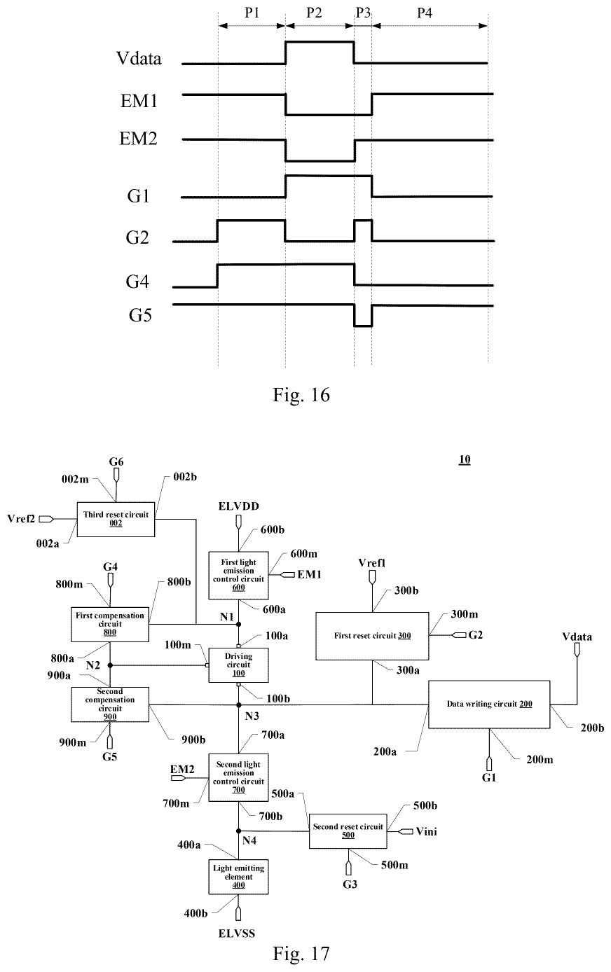

FIG. 14 is a schematic block diagram of another pixel circuit provided by at least one embodiment of the present disclosure; FIG. 15 is a circuit diagram of a specific example of the pixel circuit shown in FIG. 14; FIG. 16 is a signal timing diagram of a driving method of the pixel circuits shown in FIGS. 14 and 15 provided by at least one embodiment of the present disclosure. The structure and driving method of the pixel circuit shown in FIGS. 14-16 are different from those of the pixel circuit shown in FIGS. 1-3.

Referring to FIGS. 14 and 16, the first reset circuit 300 also serves as the second reset circuit 500, and the first reset signal terminal Vref1 also serves as the second reset signal terminal Vini, that is, the first reset signal terminal Vref1 and the second reset signal terminal Vini are the same common signal terminal, and the common signal terminal is configured to receive the first reset signal Vref1 and the second reset signal Vini at different time periods, so as to write the first reset signal Vref1 and the second reset signal Vini at different specific positions. For example, in the initial stage P1, the first reset control signal G2 is a turn-on signal and the second light emission control signal EM2 is a turn-on signal, such as a high level signal, so that both the first reset circuit 300 and the second light emission control circuit 700 are turned on, and the first reset signal terminal Vref1 (i.e., the above-mentioned common signal terminal) receives the first reset signal Vref1, and the first reset signal Vref1 is written to the second terminal 100b (third node N3) of the driving circuit 100 through the first reset circuit 300 and to the first electrode 400a (fourth node N4) of the light emitting element 400 through the second light emission control circuit 700, so that the second terminal 100b of the driving circuit 100 and the first electrode 400a of the light emitting element 400 can be reset by using the first reset signal Vref1.

In the data writing stage P2, the first reset signal G2 and the second light emission control signal EM2 are both turn-off signals, for example, low level signals, so that the first reset circuit 300 and the second light emission control circuit 700 are turned off, and the data signal Vdata is written to the third node N3. The writing process of the data signal Vdata is the same as that of the embodiment shown in FIGS. 1-3.

In the compensation stage P3, both the first reset signal G2 and the second light emission control signal EM2 are turn-on signals to turn on the first reset circuit 300 and the second light emission control circuit 700 again. The first reset signal terminal Vref1 (i.e. the above-mentioned common signal terminal) receives the second reset signal Vini, the second reset signal Vinit is written to the second terminal 100b (the third node N3) of the driving circuit 100 through the first reset circuit 300. By this method, it is also possible to make the potential V_{N3} of the third node N3 satisfy V_{N3}=Vini in the compensation stage P3, and maintain the potential of the gate electrode G of the driving transistor DT at the end of the data writing stage P2, so that the potential of the third node N3 and the potential of the gate electrode G of the driving transistor DT at this moment can be used to participate in the compensation calculation of the threshold voltage of the driving transistor DT.

In the light emitting stage P4, the first reset signal G2 is a turn-off signal, and the working process and compensation principle of the pixel circuit are the same as those of the embodiment shown in FIGS. 1-3.

Specifically, in the pixel circuit 10 shown in FIG. 15, the first reset transistor T4 also serves as the second reset transistor T6, the first reset control signal G2 also serves as the second reset control signal G3, and the first reset signal terminal Vref1 also serves as the second reset signal terminal Vini. In the initial stage P1, the first reset control signal G2 is a turn-on signal and the second light emission control signal EM2 is a turn-on signal, for example, a high level signal, so that the first reset transistor T4 and the second light emission control transistor T5 are both turned on, and the first reset signal terminal Vref1 (i.e., the common signal terminal) receives the first reset signal Vref1. The first reset signal Vref1 is written to the second electrode (third node N3) of the driving transistor DT through the first reset circuit 300 and to the first electrode 400a (fourth node N4) of the light emitting element 400 through the second light emission control transistor T5, so that the second electrode of the driving transistor DT and the first electrode 400a of the light emitting element 400 can be reset by using the first reset signal Vref1.

In the data writing stage P2, the first reset signal G2 and the second light emission control signal EM2 are both turn-off signals, for example, low level signals, so that the first reset transistor T4 and the second light emission control transistor T5 are turned off, and the data signal Vdata is written to the third node N3. The writing process of the data signal Vdata is the same as that of the embodiment shown in FIGS. 1-3.

In the compensation stage P3, both the first reset signal G2 and the second light emission control signal EM2 are turn-on signals to turn on the first reset transistor T4 and the second light emission control transistor T5 again. The first reset signal terminal Vref1 (i.e. the above-mentioned common signal terminal) receives the second reset signal Vini, the second reset signal Vini is written to the second electrode (the third node N3) of the driving transistor DT through the first reset transistor T4. In this way, it is also possible to make the potential V_{N3} of the third node N3 satisfy V_{N3}=Vini in the compensation stage P3, that is, to make the potential of the second electrode plate of the compensation capacitor C1 become Vini, and to maintain the potential of the gate electrode G of the driving transistor DT at the end of the data writing stage P2, so that the potential of the third node N3 and the potential of the gate electrode G of the driving transistor DT at this moment can be used to participate in the compensation calculation of the threshold voltage of the driving transistor DT.

In the light emitting stage P4, the first reset signal G2 is a turn-off signal to turn off the first reset transistor T4. Other control signals, the working states of other transistors, and the working process and compensation principle of the pixel circuit are the same as those of the embodiment shown in FIGS. 1-3.

Other unmentioned structures, other working processes at various stages, compensation principle for threshold voltage and corresponding technical effects of the pixel circuit and its driving method shown in FIGS. 14-16 are the same as those of the pixel circuit shown in FIGS. 1-3. Please refer to the previous description and the repeated portions are omitted here.

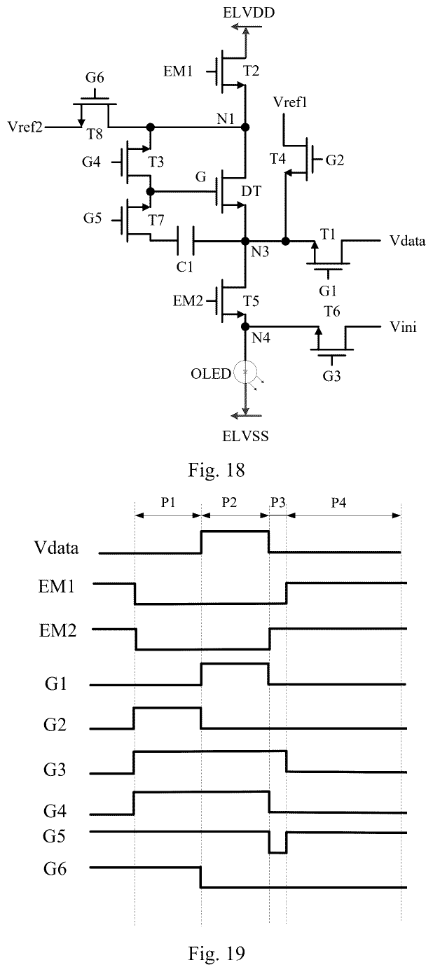

FIG. 17 is a schematic block diagram of another pixel circuit provided by at least one embodiment of the present disclosure; FIG. 18 is a circuit diagram of a specific example of the pixel circuit shown in FIG. 17; FIG. 19 is a signal timing diagram of a driving method of the pixel circuit shown in FIGS. 17-18 provided by at least one embodiment of the present disclosure. The structure and driving method of the pixel circuit shown in FIGS. 17-19 are different from those of the pixel circuit shown in FIGS. 1-3.

Referring to FIG. 14 and FIG. 17, on the basis of the pixel circuit shown in FIG. 1, the pixel circuit 10 further includes a third reset circuit 002, the control terminal of the third reset circuit 002 is configured to receive a third reset control signal G6, a first terminal of the third reset circuit 002 is electrically connected with the first terminal 100a of the driving circuit 100, a second terminal of the third reset circuit 002 is electrically connected with a third reset signal terminal Vref2 to receive the third reset signal Vref2, and the third reset circuit 002 is configured to apply the third reset signal Vref2 to the first terminal 100a of the driving circuit 100 in response to the third reset control signal G6.

On the basis of the driving method of the pixel circuit shown in FIGS. 1-3, referring to FIGS. 17 and 19, the driving method of the pixel circuit further includes: in the initial stage P1, setting the third reset control signal G6 as a turn-on signal to turn on the third reset circuit 002, and applying the third reset signal Vref2 to the first terminal 100a of the driving circuit 100 through the third reset circuit 002. In this way, in the initial stage P1, the first node N1 and the control terminal 100m of the driving circuit 100 are reset by the third reset signal Vref2.

Referring to FIG. 17 and FIG. 19, the driving method of the pixel circuit further includes: in the initial stage P1, setting the first light emission control signal EM1 as a turn-off signal, so as to turn off the first light emission control circuit 600, thereby preventing the first power supply voltage VDD from being written to the first node N1 and the control terminal 100m of the driving circuit 100. For example, the third reset signal Vref2 is a reset voltage, the rest voltage Vref2 is lower than the first power supply voltage VDD, that is, the voltage value of the third reset signal Vref2 may be lower than the voltage value of the first power supply voltage VDD. For example, the voltage value of the third reset signal Vref2 is higher than the data voltage Vdata, so that, similar to the data writing stage P2 shown in FIG. 1-3, the control terminal 100m of the driving circuit 100 will discharge to the third node N3 through the first compensation circuit 800 and the driving circuit 100 in the subsequent data writing stage P2. In this way, by setting the third reset circuit 002, in the initial stage P1, the first node N1 and the control terminal 100m of the driving circuit 100 are reset by using the third reset signal Vref2, which is more conducive to the subsequent discharge of the control terminal 100m of the driving circuit 100 to the third node N3 through the first compensation circuit 800 and the driving circuit 100 in the data writing stage P2, which improves the reliability of the pixel circuit to realize the designed working process and produces a more ideal driving effect. For example, the first power supply voltage VDD is 10V, and the third reset signal Vref2 can be 4V, 5V, 6V, etc. Of course, the specific voltage values of the first power supply voltage and the third rest signal are not limited to the enumerated values, and this is just an example.

The driving method of the pixel circuit also includes: setting the third reset control signal G6 as a turn-off signal at other stages (the data writing stage P2, the compensation stage P3 and the light emitting stage P4), so as to turn off the third reset circuit 002, so that the third reset circuit 002 will not affect the normal operation of the pixel circuit at other stages.

As illustrated by FIG. 18, for example, the third reset circuit 002 includes a third reset transistor T8, a gate electrode of third reset transistor T8 is configured to receive a third reset control signal G6, a first electrode of third reset transistor T8 is electrically connected with the first electrode of the first compensation transistor T3 and the first electrode of the driving transistor DT, and a first electrode of third reset transistor T8 is electrically connected with the third reset signal terminal Vref2 to receive the third reset signal Vref2.

Referring to FIGS. 18 and 19, the driving method of the pixel circuit further includes: in the initial stage P1, setting the third reset control signal G6 as a turn-on signal to turn on the third reset circuit 002, and the third reset signal Vref2 is applied to the first electrode of the driving transistor DT through the third reset circuit 002. In this way, in the initial stage P1, the first node N1 and the gate electrode G of the driving transistor are reset by the third reset signal Vref2.

For example, referring to FIGS. 18 and 19, the driving method of the pixel circuit further includes: in the initial stage P1, setting the first light emission control signal EM1 as a turn-off signal to turn off the first light emission control transistor T2, thereby preventing the first power supply voltage VDD from being written to the first node N1 and the gate electrode G of the driving transistor. The driving method of the pixel circuit further includes: in the initial stage P1, setting the first light emission control signal EM1 as a turn-off signal, so as to turn off the first light emission control transistor T2, thereby preventing the first power supply voltage VDD from being written to the first node N1 and the gate electrode G of the driving transistor DT. For example, the third reset signal Vref2 can be lower than the first power supply voltage VDD. Thus, by setting the third reset circuit 002, in the initial stage P1, the first node N1 and the gate electrode G of the driving transistor DT are reset by the third reset signal Vref2, which is more conducive to the discharge of the gate electrode G of the driving transistor DT to the third node N3 through the first compensation transistor T3 and the driving transistor DT in the subsequent data writing stage P2, which improves the reliability of the designed working process of the pixel circuit and produces a more ideal driving effect.

The driving method of the pixel circuit shown in FIG. 18 further includes: setting the third reset control signal G6 as a turn-off signal at other stages (the data writing stage P2, the compensation stage P3 and the light emitting stage P4), so that the third reset circuit 002 is turned off, so that the third reset circuit 002 will not affect the normal operation of the pixel circuit at other stages.

Other structures, driving methods, compensation principle for threshold voltage and corresponding technical effects of the pixel circuit shown in FIG. 18 are the same as those of the pixel circuit shown in FIGS. 1-3. Please refer to the previous description and the repeated portions are omitted here.

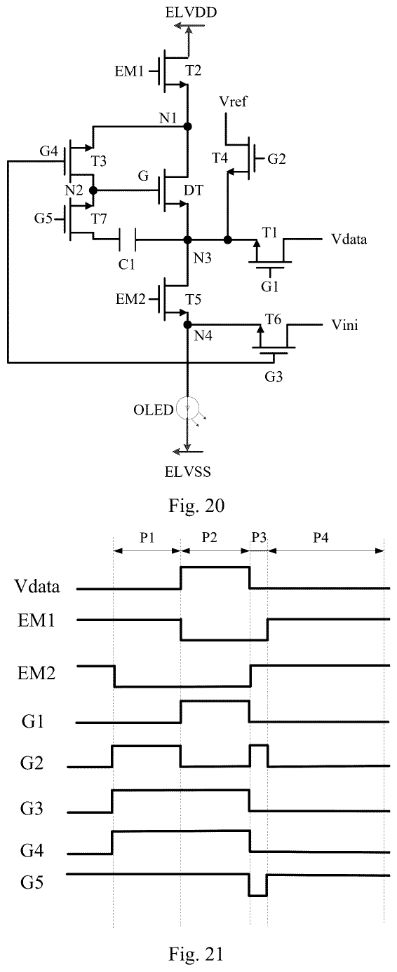

FIG. 20 is a circuit diagram of another pixel circuit provided by at least one embodiment of the present disclosure; FIG. 21 is a signal timing diagram of a driving method of the pixel circuit shown in FIG. 20 provided by at least one embodiment of the present disclosure. The structure of the pixel circuit shown in FIGS. 20 and 21 and its driving method are different from those of the pixel circuit shown in FIGS. 2 and 3 as follows.

Referring to FIG. 20, for example, the gate electrode of the first compensation transistor T3 and the gate electrode of the second reset transistor T6 are connected with the same gate line, that is, the first compensation transistor T3 and the second reset transistor T6 share the same gate electrode, and the second reset control signal G3 and the first compensation control signal G4 are the same gate scanning signals. For example, the types of the first compensation transistor T3 and the second reset transistor T6 are the same. Here, for example, both of the first compensation transistor T3 and the second reset transistor T6 are N-type transistors. Of course, in other embodiments, both of them can also be P-type transistors, and the types of turn-on and turn-off signals can be adjusted accordingly to meet their working states (on or off) in the following process.

Referring to FIG. 21, in the compensation stage P3, the first compensation control signal G4 needs to be a turn-off signal, so that the second reset control signal G3 is also a turn-off signal; in this case, both the first reset signal G2 and the second light emission control signal EM2 are turn-on signals, so that the first reset transistor T4 and the second light emission control transistor T5 are turned on, the first reset signal terminal Vref1 (i.e. the common signal terminal) receives the second reset signal Vini, and the second reset signal Vini is written to the second electrode (the third node N3) of the driving transistor DT through the first reset transistor T4. In this way, the potential V_{N3} of the third node N3 satisfies V_{N3}=Vini in the compensation stage P3, that is, the potential of the second electrode plate of the compensation capacitor C1 becomes Vini, and the potential of the gate electrode G of the driving transistor DT is maintained at the potential at the end of the data writing stage P2, so that the potential of the third node N3 and the potential of the gate electrode G of the driving transistor DT at this moment can be used to participate in the compensation calculation of the threshold voltage of the driving transistor DT.

Other structures and driving methods, compensation principle for threshold voltage and corresponding technical effects of the pixel circuits shown in FIG. 20 and FIG. 21 are the same as those of the pixel circuits shown in FIG. 1 and FIG. 2, so please refer to the previous descriptions and the repeated portions are omitted here.

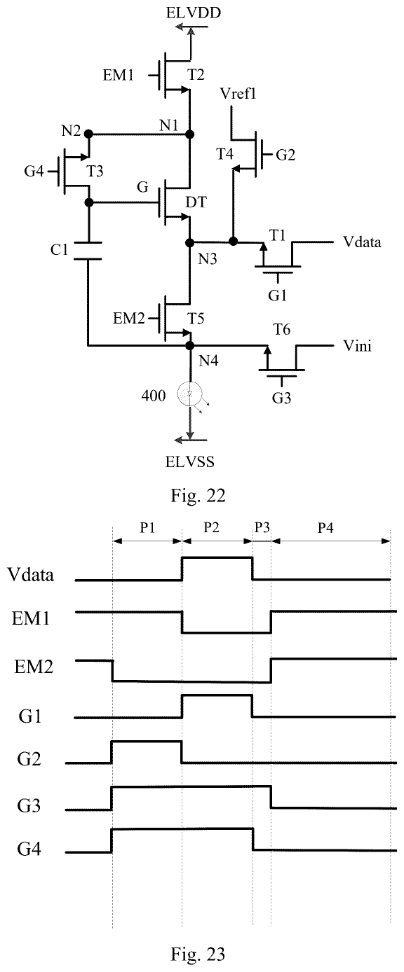

FIG. 22 is a circuit diagram of another specific example of the pixel circuit shown in FIG. 1; FIG. 23 is a signal timing chart of a driving method of the pixel circuit shown in FIG. 22. The structure and driving method of the pixel circuit shown in FIG. 22 are different from those shown in FIGS. 2-3 as follows.

Referring to FIG. 22, the second compensation circuit 900 includes a compensation capacitor C1, a first electrode plate of compensation capacitor C1 is electrically connected with the gate electrode of the driving transistor DT, and a second electrode plate of compensation capacitor C1 is electrically connected with the first electrode of the light emitting element 400. For example, the second compensation circuit 900 does not include a transistor.

For example, the first electrode plate of the compensation capacitor C1 is electrically connected with the gate electrode of the driving transistor DT, that is, there is no other switching element between the second electrode plate of the compensation capacitor C1 and the first electrode of the light emitting element 400; for example, the second electrode plate of the compensation capacitor C1 is directly electrically connected with the first electrode of the light emitting element 400, that is, there is no other switching element between the first electrode plate of the compensation capacitor C1 and the gate electrode of the driving transistor DT.

For example, the driving method and working process of the pixel circuit shown in FIG. 22 are different from those shown in FIGS. 1-3 as follows.

During the operation of the pixel circuit shown in FIG. 22, there is no second compensation control signal.

Referring to FIGS. 22 and 23, the control signals and related driving steps except the second compensation control signal and the working process of the initial stage P1 and the data writing stage P2 are the same as those shown in FIGS. 1-3.

Referring to FIGS. 22 and 23, in the compensation stage P3, setting the second reset control signal G3 as a turned-on signal and the first light emission control signal EM1 as a turn-off signal, and the second reset signal Vini is written to the first electrode 400a of the light emitting element 400 through the second reset circuit 500 (for example, through the second reset transistor T6), that is, the second reset signal Vini is written to the fourth node N4, that is, the second reset signal Vini is written to the second electrode of the second compensation capacitor C1, so that the potential V_{N4} of the first electrode of the light emitting element 400 satisfy V_{N4}=Vini. In addition, in the compensation stage P3, the potential of the control terminal 100m of the driving circuit 100 can be maintained at the potential at the end of the data writing stage P2 by using the compensation capacitor C1. Because the second electrode plate of the compensation capacitor C1 is directly electrically connected to the fourth node N4, it is not needed to write the second reset signal Vini to the third node N3 in the compensation stage P3 as long as VN4=Vini is guaranteed. Therefore, in the compensation stage P3, the second light emission control signal EM2 can be a turn-off signal (as illustrated by FIG. 22), and the second reset signal Vini is not written to the third node N3 in the compensation stage P3, which still does not affect the compensation of the threshold voltage and can simplify the driving method of the pixel circuit. Alternatively, in other embodiments, the second light emission control signal EM2 may also be a turn-on signal to turn on the second light emission control circuit 700, so that the second reset signal Vini is written to the third node N3 through the second light emission control circuit 700. For example, the second light emission control signal EM2 is a turn-on signal to turn on the second light emission control transistor T5, and the second reset signal Vini is written to the third node N3 through the second light emission control transistor T5.

For example, for the pixel circuit 10 shown in FIG. 22, in the light emitting stage P4, the first light emission control signal EM1 and the second light emission control signal EM2 are both turn-on signals, such as high level signals, so that the first light emission control transistor T2 and the second light emission control transistor T5 are turned on, and the data scanning signal G1, the first reset control signal G2, the second reset control signal G3 and the first compensation control signal G4 are all turn-off signals. For example, the data writing transistor T1, the first reset transistor T4, the second reset transistor T6 and the first compensation transistor T3 are all turned off, and finally the driving transistor DT is turned on. The first power supply voltage VDD is applied to the first electrode of the driving transistor DT, and the driving current is applied to the light emitting element 400 through the second light emission control transistor T5 to make the light emitting element 400 emit light.

In the light emitting stage P4, the compensation capacitor C1 can play a bootstrap role to change the potential of the gate electrode G of the driving transistor DT electrically connected with the first electrode plate of the compensation capacitor C1 and the potential of the fourth node N4 electrically connected with the second electrode plate of the compensation capacitor C1 by the same amount, thereby realizing the compensation for the threshold voltage of the driving transistor DT. Specifically, in the light emitting stage P4, because the light emitting element 400 is in a light emitting state, the voltage value of the first electrode of the light emitting element 400 (that is, the voltage value of the fourth node N4) and the voltage value of the second electrode of the driving transistor DT all correspond to the voltage value Voled when the light emitting element 400 emits light, that is, the voltage value of the first electrode of the light emitting element 400 (that is, the fourth node N4) is Voled; because the second light emission control circuit 700 is turned on, the voltage value of the second electrode plate of the compensation capacitor C1 is also Voled at this moment, so the change amount of the voltage value of the second electrode plate of the compensation capacitor C1 is ΔV_{N4}=Voled−Vini. Accordingly, the compensation capacitor C1 plays a bootstrap role, so that the first electrode plate of the compensation capacitor C1 also has a variation A VN4=Voled-Vini, thereby making the voltage value of the gate electrode G of the driving transistor DT (the voltage value of the second node N2) have a variation Δ V_{N4}, and the voltage value of the gate electrode G of the driving transistor DT is represented by V_{G}, so V_{G}=Vdata+Vth+Voled−Vini. The driving transistor DT is in the on state, and the gate-source voltage of the driving transistor DT is represented by V_{GS}, so V_{GS}=V_{G}−V_{N4}=(Vdata+Vth+Voled−Vini)−Voled=Vdata+Vth−Vini.

The value I of the driving current flowing through the light emitting element can be obtained according to the following formula:

I=K×(V_{GS}−Vth)²,

where k is the conductivity of the driving transistor DT. Namely:

$$I = K * {( Vdata - Vini )}^{2} .$$

According to the above formula, the value I of the driving current flowing through the light emitting element is no longer related to the threshold voltage Vth of the driving transistor DT, so that the compensation for the pixel circuit can be realized, the problem that the threshold voltage Vth of the driving transistor DT drifts due to the process and long-term operation can be solved, and the influence on the driving current can be eliminated, so that the display effect of the display device adopting the pixel circuit can be improved.

Other structures, driving methods, compensation principle for threshold voltage and corresponding technical effects of the pixel circuit shown in FIGS. 22-23 are the same as those of the pixel circuit shown in FIGS. 1-3. Please refer to the previous description and the repeated portions are omitted here.

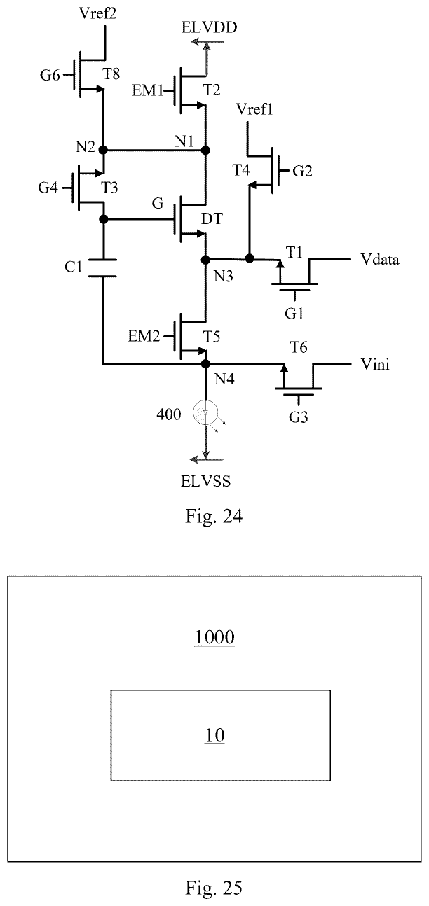

FIG. 24 is a circuit diagram of another specific example of the pixel circuit shown in FIG. 17. The pixel circuit shown in FIG. 24 has the following differences from the pixel circuit shown in FIG. 23. On the basis of the pixel circuit shown in FIG. 22, the pixel circuit shown in FIG. 24 further includes the above-mentioned third reset circuit, and the third rest circuit includes a third reset transistor T8, a gate electrode of the third reset transistor T8 is configured to receive a third reset control signal G6, a first electrode of the third reset transistor T8 is electrically connected with the first electrode of the first compensation transistor T3 and the first electrode of the driving transistor DT, and the first electrode of the third reset transistor T8 is electrically connected with the third reset signal terminal Vref2 to receive the third reset signal Vref2.

The application mode of the third reset control signal G6 and the working process and function of the third reset transistor T8 are the same as those shown in FIG. 18. Please refer to the previous description. The driving method of the pixel circuit shown in FIG. 24 only needs to add the working process of the third reset transistor T8 to the driving method of the pixel circuit shown in FIG. 22, and the repeated portions are omitted here.

Other structures, driving methods, compensation principle for threshold voltage and corresponding technical effects of the pixel circuit shown in FIG. 24 are the same as those of the pixel circuits shown in FIG. 22 and FIG. 23, so please refer to the previous descriptions and the repeated portions are omitted here.

For example, if the second compensation circuit 900 includes the compensation capacitor C1 shown in FIG. 22, it can be combined with the non-contradictory features in other embodiments to obtain a new embodiment.

At least one embodiment of the present disclosure also provides a display device, which includes any pixel circuit provided by the embodiment of the present disclosure.

FIG. 25 is a schematic block diagram of a display device provided by at least one embodiment of the present disclosure. As illustrated by FIG. 25, the display device 1000 includes any pixel circuit 10 provided by the embodiment of the present disclosure. The display device 1000 can be, for example, an organic light emitting diode display device, a quantum dot light emitting diode display device and other devices with display functions. Embodiments of the present disclosure are not limited thereto.

Other structures and functions of the display device 1000 provided by the embodiment of the present disclosure can be realized by referring to the conventional technology, and the embodiments of the present disclosure are not limited thereto. The technical effect of the display device 01 provided by the embodiment of the present disclosure can refer to the above description of the technical effect of the pixel circuit provided by the embodiment of the present disclosure, and the repeated portions are omitted here.

For example, the display device 1000 provided by at least one embodiment of the present disclosure can be a display panel, a mobile phone, a tablet computer, a television, a display, a notebook computer, a digital photo frame, a navigator and other products or components with display functions, and the embodiments of the present disclosure are not limited thereto.

For the present disclosure, the following statements should be noted:
(1) The accompanying drawings involve only the structure(s) in connection with the embodiment(s) of the present disclosure, and other structure(s) can be referred to common design(s).
(2) In case of no conflict, the embodiments of the present disclosure and the features in the embodiments can be combined with each other to obtain new embodiments.

What have been described above are only specific implementations of the present disclosure, the protection scope of the present disclosure is not limited thereto, and the protection scope of the present disclosure should be based on the protection scope of the claims.

1. A pixel circuit, comprising:
a driving circuit, comprising a control terminal, a first terminal and a second terminal, and configured to control a magnitude of a driving current flowing through the first terminal and the second terminal;
a data writing circuit, wherein a first terminal of the data writing circuit is electrically connected with a second terminal of the driving circuit, and the second terminal of the data writing circuit is configured to receive a data signal, and the data writing circuit is configured to write the data signal to the second terminal of the driving circuit in response to a data scanning signal in a data writing stage;
a first compensation circuit, comprising a control terminal, a first terminal and a second terminal, wherein a control terminal of the first compensation circuit is configured to receive a first compensation control signal, the first terminal of the first compensation circuit is electrically connected with the first terminal of the driving circuit, and the second terminal of the first compensation circuit is electrically connected with the control terminal of the driving circuit, and the first compensation circuit is configured to control the control terminal of the driving circuit and the first terminal of the driving circuit whether to be electrically conducted through the first compensation circuit in response to the first compensation control signal; and
a second compensation circuit, comprising a compensation capacitor, wherein a first electrode plate of the compensation capacitor is electrically connected with the control terminal of the driving circuit.

2. The pixel circuit according to claim 1, wherein the first compensation circuit and the second compensation circuit are configured to allow a potential of the control terminal of the driving circuit to change in response to a potential change of the second terminal of the driving circuit in the data writing stage, and to maintain the potential of the control terminal of the driving circuit in a compensation stage after the data writing stage and not allow the potential of the control terminal of the driving circuit to change in response to the potential change of the second terminal of the driving circuit.

3. The pixel circuit according to claim 1- or 2, wherein the driving circuit comprises a driving transistor, a gate electrode of the driving transistor serves as the control terminal of the driving circuit, a first electrode of the driving transistor serves as the first terminal of the driving circuit, a second electrode of the driving transistor serves as the second terminal of the driving circuit, and the first terminal of the driving circuit is electrically connected with a first power supply voltage terminal to receive a first power supply voltage;
the pixel circuit further comprises a light emitting element, the light emitting element is configured to emit light driven by the driving current, the second terminal of the driving circuit is electrically connected with a first electrode of the light emitting element, and the driving circuit is configured to control a magnitude of a driving current flowing through the light emitting element;
the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor.

4. The pixel circuit according to claim 3, wherein the second compensation circuit further comprises a second compensation transistor, a gate electrode of the second compensation transistor receives a second compensation control signal, a first electrode of the second compensation transistor is electrically connected with the gate electrode of the driving transistor, and a second electrode of the second compensation transistor is electrically connected with the first electrode plate of the compensation capacitor so that the first electrode plate of the compensation capacitor is electrically connected with the gate electrode of the driving transistor through the second compensation transistor, and a second electrode plate of the compensation capacitor is electrically connected with the second electrode of the driving transistor.

5. The pixel circuit according to claim 3, wherein the first electrode plate of the compensation capacitor is electrically connected with the gate electrode of the driving transistor, and a second electrode plate of the compensation capacitor is electrically connected with the first electrode of the light emitting element.

6. The pixel circuit according to claim 1, wherein the pixel circuit further comprises a first reset circuit, a control terminal of the first reset circuit is configured to receive a first reset control signal, a first terminal of the first reset circuit is electrically connected with the second terminal of the driving circuit, and a second terminal of the first reset circuit is electrically connected with a first reset signal terminal to receive a first reset signal, the first reset circuit is configured to write the first reset signal to the second terminal of the driving circuit in response to the first reset control signal.

7. The pixel circuit according to claim 6, wherein the first reset circuit comprises a first reset transistor, a gate electrode of the first reset transistor is electrically connected with a first reset control terminal to receive the first reset control signal, a first electrode of the first reset transistor is electrically connected with the second terminal of the driving circuit, and a second electrode of the first reset transistor is electrically connected with the first reset signal terminal to receive the first reset signal;
the data writing circuit comprises a data writing transistor, a gate electrode of the data writing transistor is configured to receive the data scanning signal, the first electrode of the data writing transistor is electrically connected with the second terminal of the driving circuit, and the second electrode of the data writing transistor is electrically connected with a data signal terminal to receive the data signal;
the data writing transistor and the first reset transistor are independent and different transistors, and the data signal terminal and the first reset signal terminal are independent and different signal terminals; or,
the data writing transistor also serves as the first reset transistor, the data scanning signal also serves as the first reset control signal, and the data signal terminal also serves as the first reset signal terminal, and is configured to receive the data signal and the first reset signal at different time periods, respectively.

8. The pixel circuit according to claim 1, wherein
the pixel circuit further comprises an auxiliary capacitor, a first electrode plate of the auxiliary capacitor is electrically connected with the second terminal of the driving circuit, and a second electrode plate of the auxiliary capacitor is electrically connected with a first reset signal terminal.

9. The pixel circuit according to claim 1, wherein the pixel circuit further comprises a light emitting element, the light emitting element is configured to emit light driven by the driving current, the second terminal of the driving circuit is electrically connected with a first electrode of the light emitting element, and the driving circuit is configured to control a magnitude of a driving current flowing through the light emitting element;
the pixel circuit further comprises a second reset circuit, a control terminal of the second reset circuit is configured to receive a second reset control signal, a first terminal of the second reset circuit is electrically connected with the first electrode of the light emitting element, and the second terminal of the second reset circuit is electrically connected with a second reset signal terminal to receive a second reset signal, the second reset circuit is configured to apply the second reset signal to the first electrode of the light emitting element and/or the second electrode plate of the compensation capacitor in response to the second reset control signal.

10. The pixel circuit according to claim 1, wherein the pixel circuit further comprises a second reset circuit, a control terminal of the second reset circuit is configured to receive a second reset control signal, a first terminal of the second reset circuit is electrically connected with the second terminal of the driving circuit, and a second terminal of the second reset circuit is electrically connected with a second reset signal terminal to receive a second reset signal, the second reset circuit is configured to apply the second reset signal to the second terminal of the driving circuit and/or the second electrode plate of the compensation capacitor in response to the second reset control signal.

11. The pixel circuit according to claim 10, wherein the first reset circuit comprises a first reset transistor, a gate electrode of the first reset transistor is electrically connected with a first reset control terminal to receive a first reset control signal, a first electrode of the first reset transistor is electrically connected with the second terminal of the driving circuit, and a second electrode of the first reset transistor is electrically connected with a first reset signal terminal to receive a first reset signal;
the second reset circuit comprises a second reset transistor, a gate electrode of the second reset transistor is electrically connected with a second reset control terminal to receive the second reset control signal, a first electrode of the second reset transistor is electrically connected with the second terminal of the driving circuit, and a second electrode of the second reset transistor is electrically connected with the second reset signal terminal to receive the second reset signal;
the first reset transistor also serves as the second reset transistor, the first reset control signal also serves as the second reset control signal, and the first reset signal terminal also serves as the second reset signal terminal, and is configured to receive the first reset signal and the second reset signal respectively in different time periods; or,
the second reset transistor and the first reset transistor are independent and different transistors, and the first reset signal terminal and the second reset signal terminal are independent and different signal terminals.

12. The pixel circuit according to claim 1, wherein the pixel circuit further comprises a third reset circuit, a control terminal of the third reset circuit is configured to receive a third reset control signal, a first terminal of the third reset circuit is electrically connected with the first terminal of the driving circuit, and a second terminal of the third reset circuit is electrically connected with a third reset signal terminal to receive the third reset signal, the third reset circuit is configured to apply the third reset signal to the first terminal of the driving circuit in response to the third reset signal.

13. The pixel circuit according to claim 12, wherein the third reset circuit comprises a third reset transistor, a gate electrode of the third reset transistor is configured to receive a third reset control signal, a first electrode of the third reset transistor is electrically connected with the first electrode of the first compensation transistor and the first terminal of the driving circuit, and the first electrode of the third reset transistor is electrically connected with a third reset signal terminal to receive the third reset signal.

14. The pixel circuit according to claim 1, wherein the first compensation circuit comprises a first compensation transistor, a first electrode of the first compensation circuit is electrically connected with the first terminal of the driving circuit, and a second electrode of the first compensation circuit is electrically connected with a control terminal of the driving circuit;
the second reset circuit comprises a second reset transistor, a gate electrode of the second reset transistor is electrically connected with a second reset control terminal to receive a second reset control signal, a first electrode of the second reset transistor is electrically connected with the second terminal of the driving circuit, and a second electrode of the second reset transistor is electrically connected with the second reset signal terminal to receive the second reset signal;
a gate electrode of the first compensation transistor and the gate electrode of the second reset transistor are connected with a same gate line, and the second reset control signal and the first compensation control signal are a same gate scanning signal.

15. The pixel circuit according to claim 10, wherein the pixel circuit further comprises a first light emission control circuit and a second light emission control circuit;
a control terminal of the first light emission control circuit is configured to receive a first light emission control signal, a first terminal of the first light emission control circuit is electrically connected with the first terminal of the driving circuit, and a second terminal of the first light emission control circuit is electrically connected with a first voltage terminal to receive a first power supply voltage, and the first light emission control circuit is configured to apply the first power supply voltage to the first terminal of the driving circuit in response to the first light emission control signal;
a control terminal of the second light emission control circuit is configured to receive a second light emission control signal, the second light emission control signal is different from the first light emission control signal, a first terminal of the second light emission control circuit is electrically connected with the second terminal of the driving circuit, a second terminal of the second light emission control circuit is electrically connected with the first electrode of the light emitting element, and the second electrode of the light emitting element is electrically connected with a second voltage terminal to receive a second power supply voltage, and the second light emission control circuit is configured to apply the driving current to the light emitting element in response to the second light emission control signal.

16. A display device, comprising the pixel circuit according to claim 1.

17. A driving method of a pixel circuit, wherein the pixel circuit pixel circuit comprises:
a driving circuit, comprising a control terminal, a first terminal and a second terminal, and configured to control a magnitude of a driving current flowing through the first terminal and the second terminal;
a data writing circuit, wherein a first terminal of the data writing circuit is electrically connected with a second terminal of the driving circuit, and the second terminal of the data writing circuit is configured to receive a data signal, and the data writing circuit is configured to write the data signal to the second terminal of the driving circuit in response to a data scanning signal in a data writing stage;
a first compensation circuit, comprising a control terminal, a first terminal and a second terminal, wherein a control terminal of the first compensation circuit is configured to receive a first compensation control signal, the first terminal of the first compensation circuit is electrically connected with the first terminal of the driving circuit, and the second terminal of the first compensation circuit is electrically connected with the control terminal of the driving circuit, and the first compensation circuit is configured to control the control terminal of the driving circuit and the first terminal of the driving circuit whether to be electrically conducted through the first compensation circuit in response to the first compensation control signal; and
a second compensation circuit, comprising a compensation capacitor, wherein a first electrode plate of the compensation capacitor is electrically connected with the control terminal of the driving circuit;
the driving method of the pixel circuit comprises:
in the data writing stage, setting the data scanning signal as a turn-on signal to turn on the data writing circuit, wherein the data signal is written to the second terminal of the driving circuit through the data writing circuit, and the potential of the control terminal of the driving circuit changes in response to the potential change of the second terminal of the driving circuit by controlling the first compensation circuit and the second compensation circuit; and
in a compensation stage after the data writing stage, controlling the first compensation circuit and the second compensation circuit to maintain the potential of the control terminal of the driving circuit, wherein the potential of the control terminal of the driving circuit is not allowed to change in response to the potential change of the second terminal of the driving circuit.

18. The driving method of the pixel circuit according to claim 17, wherein in the data writing stage, the first compensation control signal is set as a turn-on signal to turn on the first compensation circuit in response to the first compensation control signal, the control terminal of the driving circuit and the first terminal of the driving circuit are electrically conducted through the first compensation circuit, and the first terminal of the driving circuit and the second terminal of the driving circuit are electrically conducted, as to generate a compensation current between the control terminal of the driving circuit and the second terminal of the driving circuit, and the compensation current flows through the first compensation circuit and the driving circuit, so that the potential of the control terminal of the driving circuit changes in response to the change of a potential of the second terminal of the driving circuit;
in the compensation stage, at least the first compensation control signal is set as a turn-off signal to turn off the first compensation circuit, so that no current is allowed to generate between the control terminal of the driving circuit and the second terminal of the driving circuit, and the potential of the control terminal of the driving circuit is maintained unchanged, and the potential of the control terminal of the driving circuit is not allowed to change in response to the potential change of the second terminal of the driving circuit.

19. The driving method of the pixel circuit according to claim 18, wherein the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit;
the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor;
the second compensation circuit further comprises a second compensation transistor, a gate electrode of the second compensation transistor receives a second compensation control signal, a first electrode of the second compensation transistor is electrically connected with the gate electrode of the driving transistor, and a second electrode of the second compensation transistor is electrically connected with the first electrode plate of the compensation capacitor so that the first electrode plate of the compensation capacitor is electrically connected with the gate electrode of the driving transistor through the second compensation transistor, and a second electrode plate of the compensation capacitor is electrically connected with the second electrode of the driving transistor;
the pixel circuit further comprises a light emitting element, the light emitting element is configured to emit light under driving of the driving current, wherein the second terminal of the driving circuit is electrically connected with a first electrode of the light emitting element, and the driving circuit is configured to control a magnitude of a driving current flowing through the light emitting element;
the driving method of the pixel circuit comprises:
in the data writing stage, setting the first compensation control signal and the second compensation control signal as turn-on signals, so that both the first compensation transistor and the second compensation transistor are turned on to generate the compensation current; and
in the compensation stage, turning off both the first compensation transistor and the second compensation transistor to maintain the potential of the control terminal of the driving circuit unchanged;
the driving method of the pixel circuit further comprises:
in an initial stage, setting the second compensation control signal as a turn-on signal to turn on the second compensation transistor.

20. (canceled)

21. The driving method of the pixel circuit according to claim 18, wherein the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit;
the first compensation circuit comprises a first compensation transistor, a gate electrode of the first compensation transistor receives the first compensation control signal, a first electrode of the first compensation transistor is electrically connected with the first electrode of the driving transistor, and a second electrode of the first compensation transistor is electrically connected with the gate electrode of the driving transistor;
the pixel circuit further comprises a light emitting element configured to emit light under driving of the driving current, wherein the second terminal of the driving circuit is electrically connected with a first electrode of the light emitting element, and the driving circuit is configured to control a magnitude of a driving current flowing through the light emitting element;
the first electrode plate of the compensation capacitor is electrically connected with the gate electrode of the driving transistor, and a second electrode plate of the compensation capacitor is electrically connected with the first electrode of the light emitting element;
the driving method comprises:
in the data writing stage, setting the first compensation control signal as a turn-on signal to turn on the first compensation transistor to generate the compensation current; and
in the compensation stage, setting the first compensation control signal as a turn-off signal to turn off the first compensation transistor to maintain the potential of the control terminal of the driving circuit unchanged.

22-33. (canceled)
